(19) United States
(12) Patent Application Publication
(10) Pub. No.: US 2026/0281047 A1
(43) Pub. Date: Sep. 17, 2026

(54) METHODS FOR CONTROLLING A PDCP TRANSMITTER AND RECEIVER

(71) Applicant: CANON KABUSHIKI KAISHA, Tokyo (JP)

(72) Inventors: Yacine EL KOLLI, Cesson-Sévigné (FR); Pierre VISA, Cesson-Sévigné (FR); Pascal LAGRANGE, Cesson-Sévigné (FR)

(21) Appl. No.: 19/472,615

(22) PCT Filed: Apr. 4, 2024
(86) PCT No.: PCT/EP2024/059263

§ 371 Date: Oct. 3, 2025

(30) Foreign Application Priority Data
Apr. 6, 2023 (WO) PCT/FR2023/000039
Apr. 20, 2023 (GB) 2305847.2
May 11, 2023 (GB) 2306978.4
Feb. 15, 2024 (GB) 2402135.4

(51) Int. Cl. H04L 47/32; H04W 28/06

(52) U.S. Cl. CPC H04L 47/32; H04W 28/06

(57) ABSTRACT

Methods for controlling a PDCP transmitter and a PDCP receiver to result in a reduction in the delay for PDCP PDU delivery due to an unreceived previous PDCP PDU without overly increasing overhead are described.

### FIELD OF THE INVENTION

The present invention generally relates to methods for controlling a PDCP transmitter and a PDCP receiver. More particularly, the present invention relates to extended reality (XR) in 3GPP 5G NR.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations.

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems based on IEEE 802.11 standards, such as Wi-Fi.

Among the requirements for 5G NR, there are service requirements related to extended reality (XR).

XR (extended Reality) applications is defined in 3GPP document RP-2200285 as “various types of augmented, virtual, and mixed environments, where human-to-machine and human-to-human communications are performed with the assistance of handheld and wearable end user devices.”

Various uses cases can be found in 3GPP document TR-26.928.

Many XR applications involves interactions between a wearable device (for example a 3D helmet or augmented reality glasses) and an application server. The wearable device and the application server can be connected through a local Network (like a wireless LAN) or cellular network (like 3GPP 5G cellular network, the application server being connected to the 5G core network part).

Some XR applications like cloud gaming, involves transferring compressed video data, audio data from the server to the UE and position information from the UE to the server.

Some XR applications like virtual reality, involves transferring compressed video data, audio data and various information from the server to the wearable device.
Some XR applications like augmented reality, involves transferring compressed video data, audio data and various information exchanged to and from the wearable device and the server. In the present disclosure, the information exchanged to and from the UE or wearable device and the server is referred to as application data. For example, application data may comprise one or more images, video data, audio data, position information and various information. The video and audio data are transferred between the wearable device (or the user equipment) and the server using media transport protocols like RTP (Real Time Protocol, RFC 3550), SRTP (Secured RTP, RFC 3711), HTTP (Hyper Text Transfer Protocol, RFC 2616-7540) or QUIC (RFC 8999, 9000, 9001 and 9002).

Video encoding and decoding can be performed according to various formats including MPEG2, H.264, H.265, HEVC, etc..

Applications generate data in the form of encoded video, audio or position information. These data are primarily arranged in data packets by the application, an application data packet representing one unit of information is generated at the application level. 3GPP named the set of PDUs (Protocol Data Unit or Packet Data Unit) necessary to transport an application data packet a “PDU Set”. Application data comprises one or more application data packets. In downlink, 3GPP PDUs are formatted by the core network PDU Layer. In the same way, in uplink, the 3GPP PDUs are formatted by the UE (User Equipment) PDU layer. In 3GPP the delimitations of the PDU Sets (start, stop, length) are not provided by the application but generated by the core network (respectively the UE) through media transport protocol packet inspection. The detailed procedure can be found in 3GPP document TR-23.700-60.

A PDU Set is composed of one or more PDUs carrying the payload of one unit of information generated at the application level (e.g. a frame or video slice for XRM Services, as used in TR 26.926). In some implementations all PDUs in a PDU Set are needed by the application layer to use the corresponding unit of information. In other implementations, the application layer can still recover parts all or of the information unit, when some PDUs are missing. For example, one PDU Set may comprise the data of one image or frame from a video stream.
In downlink the PDU Set identification information calculated by the core network UPF (User Plane Function) are inserted in the GTP-U (GPRS Tunneling Protocol—User Plane, TS 29.281) header. GTP-U is the protocol used by the UPF to transport data from the core network to the gNB. When GTP-U PDUs arrives at gNB SDAP (Service Data Adaptation layer, TS 37.324), the GTP-U header is removed and the PDU Set identification information is no more provided in-band. Hence the UE side (receiving side) in downlink does not have access to the PDU Set identification information.

In uplink the PDU Set identification information calculated by the UE PDU layer are not inserted in any header, so the PDU Set identification information are not provided in-band. Hence the gNB side (receiving side) in uplink does not have access to the PDU Set identification information. To summarize, at all protocol layers (including the PDCP layer), the receiving entity does not have knowledge of the PDU Sets identification information, not in downlink nor in uplink.

On the transmit side, all layers below SDAP layer (e.g. PDCP transmitting entity) do not have access to in-band PDU Set identification information, but some internal mechanisms are easy to imagine to associate out-band PDU Set delimitation information to each PDU. For example, in the gNB, the GTP-U receiving entity can associate out-band PDU Set delimitation information to each PDU, and pass them to PDCP transmitting entity. Another example is in the UE, the PDU layer can associate out-band PDU Set delimitation information to each PDU and pass them to the PDCP transmitting entity.

The network used to transport the application data can experience perturbation and congestion. It is therefore possible that some PDUs of a PDU Set are missing or are late at the receiving side (UE PDU layer in downlink, Core network UPF in uplink).

Some video decoder implementation requires the reception of a complete application data packet (complete PDU Set), received on time, to adequately decode a video. While other implementation can tolerate late arrival of data packets or partial delivery of data packets of a PDU Set. For example, these implementations rely on FEC (Forward Error Correction) technology or concealment techniques.

3GPP, in document TR-23.700-60, defined a PDU Set QoS parameter called PSDB (PDU Set Delay Budget) that defines a time budget allocated to the transport of the PDU Set across the 5G system. This QoS parameter defined by the application is used by a 5G system to assess if a PDU Set (application data packet) is delivered on time.

In the same 3GPP document, TR-23.700-60, another QoS parameter named PSII (PDU Set Integrated Indication) is defined to characterize the decoder tolerance to loss or outdated data. If PSII parameter is set to “true”, then the decoder can only handle complete application data packet received on time. If PSII is set to “false”, then the decoder can tolerate both incomplete and delayed application data packets. In other 3GPP documents, PSII QoS parameter is also named PSIHI (PDU Set Integrated Handling Indication).

In the 5G system, at a radio network part, when a PDU Set is being sent over the air interface, some information is available regarding the reception status of the PDUs and the elapsed time of the PDU Set Delay Budget. For example, when a PDU Set is being transferred over the air, a RAN node (Radio Access Network node, either UE or gNB) can detect that one PDU transmission has failed despite all the retransmissions and error correction mechanisms. In that case, if the PSII QoS parameter is set to “true”, it means the entire PDU Set is useless to the application. In that case if PDUs of this “useless” PDU Set are pending transmission over the air interface, then the RAN node can consider discarding the remaining transmission of these PDUs thus achieving radio network resource saving.

In 3GPP document RP-223502, PDU Set discarding has been set as an objective for the enhancement of the Radio Access Network in order to increase the 5G system capacity to handle XR applications.

3GPP 5G systems have two modes for delivering data to applications: in-sequence delivery and free delivery. In-sequence delivery comprises delivering the application data packets by the network to the application (the application server or the UE) in the same order as they were delivered by the application (the application server or the UE) to the network. Free delivery means that packet ordering is not guaranteed.

In 5G RAN (Radio Access Network), there are various causes that can provoke a change in packet ordering. For example, retransmission based on windowed acknowledgement techniques like the one used in certain configurations of the RLC (Radio Link Control, TS 38.322) layer or the hybrid ARQ (Hybrid Automatic Repeat reQuest) used in certain configurations of the MAC layer (TS 38.321). Carrier aggregation and dual connectivity are also known to cause change in packet ordering.

In 5G RAN, the PDCP (Packet Data Convergence Protocol, TS 38.323) layer can be configured to perform packet re-ordering. Since PDCP layer is also used to reconcile data from dual connectivity or carrier aggregation, and since the upper layers above PDCP do not implement retransmission, if PDCP layer is configured to perform re-ordering of packets on 5G RAN part of the 5G system, in-order delivery of packets is guaranteed.

PDCP layer implements in-sequence delivery by monitoring PDCP PDUs sequence numbers. PDCP PDUs include a sequence number in their headers. This sequence number is incremented by the PDCP sending entity (UE in uplink, gNB in downlink). When in-sequence delivery is configured, the PDCP receiving entity, when receiving a new PDCP PDU, shall check the PDU sequence number and, if the new sequence number follows the previously received sequence number, the PDCP receiving entity shall deliver the PDCP PDU to upper layers. If the new sequence number does not follow the previously received sequence number, then a sequence number gap is detected and the PDCP receiving entity shall not deliver the PDCP PDU to upper layers until all missing PDCP PDUs (those with sequence numbers lower than current sequence number and higher than the previously received sequence number) are received. The waiting for missing packets is time bounded, after a configured amount of time is elapsed, missing PDCP PDUs are considered definitively lost and current PDCP PDU is delivered to higher layer (upper layers). The missing PDCP PDUs will be discarded if received after the waiting time is elapsed. The waiting time is controlled by a time counter named “t-ordering” and also referred to as the re-ordering counter. The value of the waiting time is configured by the gNB (for both uplink and downlink) within a range from 1 millisecond to 3 seconds (see 3GPP document TS 38.331).

According to 3GPP document R2-2300087, from the perspective of the core network and the application layer, it is preferred that the 5G RAN sub-system provides in-sequence delivery of packets, especially when it does not induce too much extra latency.

Special care must be taken to avoid excessive delay being introduced for packet reordering.

For XR, two functions will be handled by PDCP, the PDU Set discarding as per RAN2 agreement (R2-2304202, Report on LTE legacy, XR, QoE and MUSIM) and the re-ordering of PDUs.

According to R17 PDCP specification TS 38.323, Packet Data Convergence Protocol (PDCP) specification, (Release 17), PDU discard shall be indicated to lower layer.

At lower layer, discarding PDUs with allocated sequence numbers (SN) creates gaps in PDCP sequence numbers at the receiving entity.

This issue has been recognized and left for implementation in previous releases as stated in a note in TS 38.323, Packet Data Convergence Protocol (PDCP) specification, (Release 17): “Discarding a PDCP SDU already associated with a PDCP SN causes a SN gap in the transmitted PDCP Data PDUs, which increases PDCP reordering delay in the receiving PDCP entity. It is up to UE implementation how to minimize SN gap after SDU discard”.

By combining both the PDU Set discarding and the PDU reordering at PDCP layer, the following unwanted behaviour may happen:

Assuming the PDCP transmitting entity is sending PDCP PDUs belonging to a first PDU Set. The PDCP transmitting entity is aware of the PDU Set identification information thanks to out-band signalling. If at some point the PDCP transmitter detects that a PDU Set discarding condition is met concerning the PDU Set it is currently sending, then it shall discard the remaining PDCP PDUs belonging the PDU Set it is currently sending, thus saving radio resources. As said earlier the PDU Set discarding conditions includes PSII (PDU Set Integrated Indication) QoS parameter, delay budget and PDU loss. And at some other point, the PDCP transmitting entity starts sending PDCP PDUs belonging to a second PDU Set.

At the receiving entity, the delivery to upper layers of the PDCP PDUs belonging to the second PDU Set may experience an additional delay of, at most, the value of the re-ordering counter (from 1 millisecond up-to 3 seconds) whilst waiting for PDCP PDUs belonging to the first PDU Set that will never be received because they will have been discarded.

The worst case happens when the re-ordering timer starts counting only upon reception of the first PDCP PDU of the second PDU Set. This means that the previously received PDCP PDU has a non-contiguous sequence number compared to the newly received PDCP PDU.

Taking a closer look to the impact of re-ordering delay, RRC specifications TS 38.331, Radio Resource Control (RRC) protocol specification, (Release 17), defined t-ordering counter value as enumerated ms (millisecond) values from 0 to 3000.

In RAN2 technical report TR 38.835, NR; Study on XR enhancements for NR, (Release 18), a target latency of 10 ms for video is proposed. Meaning t-ordering values of 1 ms, 2 ms, 4 ms, 5 ms or 8 ms represents already 10% to 80 % of the total delay budget.

This additional delay clearly contradicts 3GPP statements mentioned earlier that in-sequence delivery by RAN (UE or gNB) is preferred unless additional delay is introduced. Indeed, one millisecond to 3 seconds additional delay is not acceptable considering end-to-end latency requirement in the order of 10 milliseconds (3GPP document TR-38.835). Leaving such uncertainty managed only by implementation choice makes it difficult to assess the fulfilment of an important requirement for XR.

In document R2-2300518, Samsung suggested that the PDU Set delimitation information is transported in-band, for example in PDCP header. Then the PDCP receiver having knowledge of the PDU Set delimitation information would have been able to implement per PDU Set in-sequence delivery procedure preventing the discarding of one PDU Set influencing the delivery time of a second PDU Set.

But in-band signalling of PDU Set delimitation information represents too much added overhead, and there is a high risk to defeat the purpose of bandwidth saving by PDU Set discarding. Therefore, there is a need to provide a method to minimize the additional delay due to in-sequence delivery of PDCP PDUs in the event of PDU Set Discarding while minimizing the induced overhead.

### SUMMARY

The present disclosure relates to the transmission of data using a packet data convergence protocol, PDCP, in a communication network comprising a transmitter and a receiver. In particular, the disclosure is directed towards the provision of a PDU Set Keep Indication which indicates at least one PDU (e.g., of a plurality of PDUs) for the receiver to keep and/or at least one pending PDU for the receiver to discard.

In accordance with a first aspect of the present invention, there is provided a method for controlling a packet data convergence protocol, PDCP, in a communication network comprising a transmitter and a receiver, the method at the transmitter comprising: transmitting protocol data units, PDUs, of application data to the receiver, determining that a first PDU Set of the PDUs of the application data has not been fully received by the receiver; and transmitting, to the receiver, a PDU Set Keep Indication to indicate one or more second PDUs of the PDUs of the application data for the receiver to keep. The one or more second PDUs may not belong to the first PDU Set.

The PDU Set Keep Indication may be sent separately to the PDUs of the application data.

The PDU Set Keep Indication may be inserted into a second PDU of the one or more second PDUs of the application data, the one or more second PDUs belonging to a second PDU Set.

The PDU Set Keep Indication may be included in a control PDU.

The PDU Set Keep Indication may be one bit in the second PDU or may be an addition to the header of the second PDU.

The real issue arises when a second PDU Set is being sent, so it is not mandatory to send a signalling immediately when a PDCP discard occurs. Different PDU Sets can be multiplexed in the same DRB. At PDCP receiving entity, there may be several SN gaps, some related to an explicit discard operation performed by the remote PDCP transmitting entity and some related to transmission errors. The discard signalling sent by the remote PDCP transmitting entity shall allow the PDCP receiving entity to discern clearly between the existing gaps.

The PDCP discard signalling may include information about PDUs belonging to different PDU Sets.

The method may further comprise: setting a PDU Set Keep Indication flag to indicate to a PDCP function implemented at the transmitter to send the PDU Set Keep Indication when a second PDU of the one or more second PDUs is ready to be sent to the receiver.

The method may further comprise: setting a PDU Set Discard flag to indicate to a PDCP function implemented at the transmitter to discard one or more data units of the application data belonging to the first PDU Set.

If the received data units of the application data belonging to the first PDU Set have been sent, by the PDCP function, to a lower layer, the method may further comprise notifying the lower layer to discard any on-going transmission of the first PDUs.

The method may further comprise: initialising a discard timer upon receiving, at a PDCP function implemented at the transmitter, a service data unit, SDU, from an upper layer, wherein the determining that the first PDU Set has not been fully received by the receiver may comprise determining that the discard timer has expired without receiving acknowledgement of reception of the first PDU Set from the receiver.

The discard timer may be a PDU Discard timer started when receiving the SDU from the upper layer or a PDU Set Discard timer started when receiving a first SDU of a PDU Set.

The determining that the first PDU Set has not been fully received may comprise receiving a report from the receiver indicating that the first PDU Set has not been fully received.

The method may further comprise: determining the PDU Set Handling Integrated Indication, PSIHI, PDU Set QoS parameter for the first PDU Set, wherein the PDU Set Keep Indication may be transmitted to the receiver only if the value of PSIHI parameter is set to a predetermined value.

The PDU Set sequence number of the first PDU Set may be used to identify the first one or more PDUs.

At least one PDU of the first PDU Set (e.g., which are transmitted to the receiver) may be configured to be stored by the receiver. At least one of the one or more second PDUs may be discarded from a memory buffer.

The method may further comprise: determining if the first PDU Set is part of an extended Reality, XR, PDU Set, wherein the PDU Set Keep Indication may be transmitted to the receiver only if the first PDU Set is an XR PDU Set.

In accordance with a second aspect of the present invention, there is provided a method for controlling a packet data convergence protocol, PDCP, in a communication network comprising a transmitter and a receiver, the method at the receiver comprising: receiving a protocol data unit, PDU, of application data from the transmitter; storing the received PDU in a memory buffer; receiving a PDU Set Keep Indication from the transmitter, wherein the PDU Set Keep Indication is to indicate PDUs for the receiver to keep; and/or discarding one or more pending PDUs stored in the memory buffer not indicated by the PDU Set Keep Indication.

The stored PDU may belong to a first PDU Set of the application data. The one or more pending PDUs stored in the memory buffer may not belong to the first PDU Set.

The method may further comprise: initialising a re-ordering timer when receiving an out of order PDU, and resetting the re-ordering timer after receiving the PDU Set Keep Indication.

The receiving the PDU Set Keep Indication may comprise checking a header of the received PDU for the PDU Set Keep Indication.

The receiving the PDU Set Keep Indication may comprise receiving the PDU Set Keep Indication separately to the PDU of the application data.

The discarding pending PDUs may comprise discarding one or more pending PDUs received before the PDU Set Keep Indication.

The method may further comprise delivering, by a PDCP function implemented at the receiver, a stored PDU to an upper layer based on the PDU Set Keep Indication.

The PDU Set Keep Indication may be indicative of the first PDU Set having not been fully received by the receiver.

The transmitter may be a PDCP transmitter and the receiver may be a PDCP receiver.

In accordance with a third aspect of the present invention, there is provided a transmitter as recited in claim 22 of the accompanying claims.

In accordance with a fourth aspect of the present invention, there is provided a receiver as recited in claim 23 of the accompanying claims.

In accordance with a fifth aspect of the present invention, there is provided a computer program as recited in claim 24 of the accompanying claims.

In accordance with a sixth aspect of the present invention, there is provided a computer-readable medium as recited in claim 25 of the accompanying claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by one or more processing units, cause the one or more processing units to carry out the method of any aspect or example described above and a computer readable storage medium carrying the computer program.

### BRIEF DESCRIPTION OF THE DRAWINGS

Different aspects of the invention will now be described, by way of example only, and with reference to the following drawings in which:

FIG. 1 is a schematic diagram illustrating a first example wireless communication system in which the present invention may be implemented according to one or more embodiments of the invention;

FIG. 2 illustrates a block schematic diagram of an example configuration of a UE in which the present invention may be implemented according to one or more embodiments of the invention;

FIG. 3 illustrates a block schematic diagram of an example configuration of a base station in which the present invention may be implemented according to one or more embodiments of the invention;

FIG. 4 is a block schematic diagram illustrating the data plane protocol stack of a 5G NR systems as represented in FIG. 1;

FIG. 5 is a block schematic diagram of an example embodiment of a PDCP protocol layer according to 3GPP document TS 38.323;

FIG. 6a is a schematic and simplified diagram of an example message flow illustrating the re-ordering function of a PDCP receiving entity according to 3GPP document TS 38.323;

FIG. 6b is a schematic and simplified diagram of another example message flow illustrating the re-ordering function of a PDCP receiving entity according to 3GPP document TS 38.323;

FIG. 7a is a schematic and simplified diagram of an example message flow illustrating the re-ordering function of a PDCP receiving entity according to an embodiment of the invention;

FIG. 7b is a schematic and simplified diagram of another example message flow illustrating the re-ordering function of a PDCP receiving entity according to an embodiment of the invention;

FIG. 8 is a flow chart illustrating an example method executed by a PDCP transmitting entity for handling a PDU discard condition according to an embodiment of the invention;

FIG. 9 is a flow chart illustrating an example method executed by a PDCP transmitting entity for PDU transmission according to an embodiment of the invention;

FIG. 10 is a flow chart illustrating an example method executed by a PDCP receiving entity for PDU reception according to an embodiment of the invention;

FIG. 11 is a flow chart illustrating an example method executed by a PDCP receiving entity for PDU Set Keep Indication control PDU reception according to an embodiment of the invention;

FIG. 12a is a block schematic diagram illustrating a PDCP Data PDU for DRBs and MRBs with 12 bits PDCP SN according to an embodiment of the invention;

FIG. 12b is a block schematic diagram illustrating a PDCP Data PDU for DRBs and MRBs with 18 bits PDCP SN according to an embodiment of the invention;

FIG. 12c is a block schematic diagram illustrating a PDCP Data PDU for sidelink DRBs for unicast with 18 bits PDCP SN according to an embodiment of the invention;

FIG. 13a is a block schematic diagram illustrating a PDCP Data PDU for DRBs and MRBs with 12 bits PDCP SN according to an embodiment of the invention;

FIG. 13b is a block schematic diagram illustrating a PDCP Data PDU for DRBs and MRBs with 18 bits PDCP SN according to an embodiment of the invention;

FIG. 13c is a block schematic diagram illustrating a PDCP Data PDU for sidelink DRBs for unicast with 18 bits PDCP SN according to an embodiment of the invention; and

FIG. 14 is a block schematic diagram illustrating a PDCP Control PDU for PDU Set Keep Indication according to an embodiment of the invention.

### DETAILED DESCRIPTION

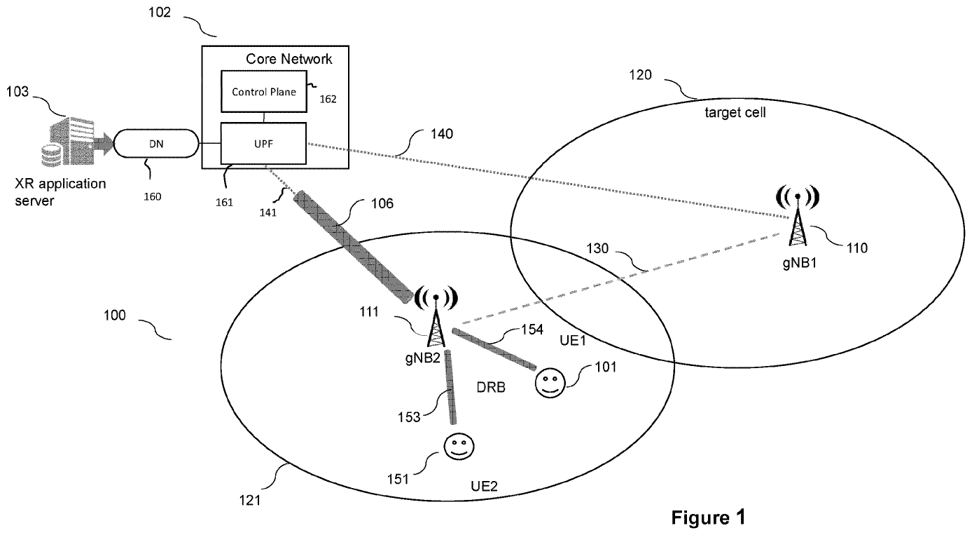

FIG. 1 illustrates an example wireless communication system 100, in particular a mobile radio communication system such as a fifth-generation (5G) New Radio (NR) system supporting extended reality service (XR). Although in the following description, embodiments and examples of embodiments of the present invention will be described with respect to a 5G NR system, it will be appreciated that it is not intended that the present invention is limited to 5G NR systems and may be used in any wireless communication systems supporting XR or similar service.

The system 100 comprises a User Equipment (UE) 101 (or 151), which may be for instance a virtual reality helmet or extended reality wearable (e.g., a pair of glasses), served by a base station 110 to communicate with a core network, such as the 5G core network 102. The UE may be any wireless device, such as a wireless communication device or apparatus or terminal, IoT device, Machine Type Communication (MTC) device, Device to Device (D2D) terminal, user device (e.g. smart phone, laptop, mobile phone, tablet, camera, game console, wearable device), capable of wireless communication with one or more core networks via one or more Radio Access Networks. The base station 110 is a network node which provides an access point to the core network for a UE and is part of the Radio Access Network (RAN) composed of the base stations 110, and 111. In NR, base stations are referred to as next-generation Node Bs (gNBs), the RAN is a Next Generation (NG) RAN and the core network is referred to as the 5GC. In the following, the terms RAN node, base station and gNB will be used interchangeably. The base stations 110 and 111 are interconnected by means of the Xn interface (specified in the 3GPP document TS 38.423) implemented on the wired or wireless link 130. Each base station is connected to the core network 102 by means of the NG interface (specified in the 3GPP document TS 38.413) implemented on the wired or wireless links 140 and 141.

Each of these base stations controls one or multiple cells. For instance, the base station 110 controls the cell 120, and the base station 111 controls the cell 121. A cell is a geographical area of a radio network defined by the frequency used in the cell to transmit data. The cell can be uniquely identified by a UE from an identification that is broadcasted over a geographical area. Each base station 110, 111 can serve several UEs like the UE 101 or UE 151. Once a UE has established a RRC connection with a base station, the base station, to which the UE is connected, is referred to as the serving base station or source base station of the UE and the cell which is controlled by the serving base station, and on which the UE camps, is referred to as the serving cell. The interface between a gNB and a UE is the Uu interface using the protocol sublayers SDAP (Service Data Adaptation Protocol), PDCP (Packet Data Convergence Protocol), RLC (Radio Link Control), MAC (Medium Access Control), PHY (Physical) in the user plane, and the protocol sublayers RRC (Radio Resource Control), PDCP, RLC, MAC, PHY in the control plane.

It is assumed that the UE 101 is receiving and/or sending XR data of one or more multicast XR sessions generated and/or destinated to the XR application server 103. The XR data are provided to the base station 111, which is the base station controlling the cell 121 on which the UE 101 is attached, through the core network 102 (through the Data Network 160 and the User Plane Function 161) and the transport bearer (also known as GTP-U tunnel) 106 over the link 141. Then, the XR data are transmitted by the base station 111 to the UE 101 through the Data Radio Bearer (DRB) 154. FIG. 1 also shows the UE 151 receiving data through DRB 153. A radio bearer is a set of PHY (layer 1) and MAC (layer 2) parameters allowing higher layer data connection between a UE and a gNB. Multiple types of radio bearers are defined in 5G NR: the SRB (Signalling Radio Bearer) for the control plane, the DRB (Data Radio Bearer) allowing point-to-point communication with one UE in the user plane (unicast), and the MRB allowing point-to-point communication and point-to-multipoint communication with multiple UEs (multicast/broadcast), also in the user plane.

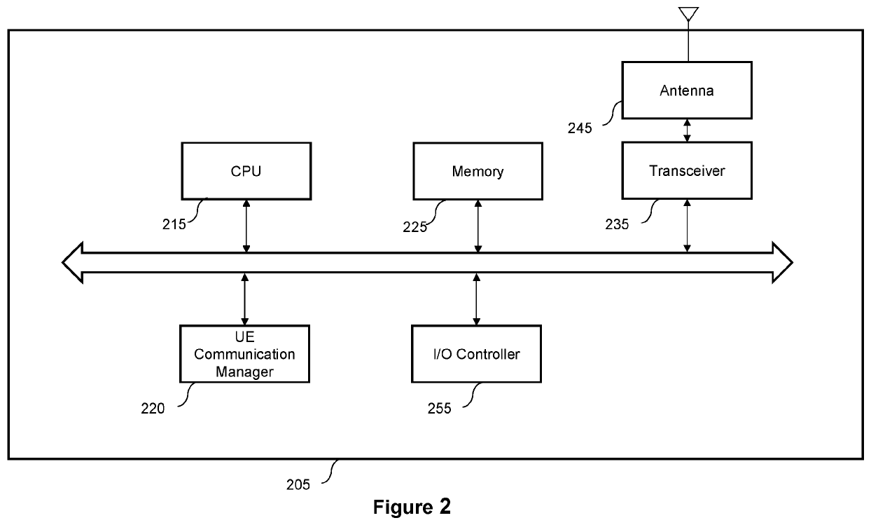

FIG. 2 illustrates a block diagram of a UE device 205, like the UE 101 or UE 151 in the FIG. 1, in which the present invention may be implemented according to one or more embodiments of the invention. The UE includes components for transmitting and receiving communications, for example including at least one of a UE communication manager 220, a I/O controller 255, a transceiver 235, a set of antennas 245, memory 225, and a processor (CPU: Central Processing Unit) 215. All these elements may communicate with each other. Memory 225 includes RAM (Random Access Memory), ROM (Read Only Memory), or combination of both or as a non-limiting example a mass storage device such as a disk or a Solid-State Drive. Basic Input Output System (BIOS) Instructions may be stored within the memory 225.

The processor 215 is configured to execute machine readable instructions. Execution of these machine-readable instructions causes the UE to perform various functions. These functions may be related to transmission or to interaction with peripheral devices like for instance a keyboard, a screen, a mouse, etc. (not shown in FIG. 2). The processor may run an operating system like for instance, iOS, Windows, Android, etc.. The processor 215 may be a single processor or may comprise two or more processors carrying out the processing required for the operation of the UE 205. The number of processors and the allocation of processing functions to the processors is a matter of design choice for a skilled person.

The I/O controller 255 allows these interactions with external peripherals by providing the hardware required and by managing input and output signals.

The transceiver 235 is configured to provide bi-directional wireless communication with other wireless devices. For example, it provides the necessary modems and frequency shifters necessary to connect to one or more wireless networks, such as Wi-Fi, Bluetooth, LTE, 5G NR, etc.. The transceiver 235 may comprise a PDCP transmitter and a PDCP receiver. The PDCP transmitter and the PDCP receiver may be implemented by the processor 215. The PDCP transmitter and the PDCP receiver may be a software only function implemented by the processor 215.

The radio communications use the antenna set 245 adapted to the spectrum of the frequency transposed signals, issued from the baseband modems. The antenna set 245 may be limited to one antenna, but preferably it contains several antennas, in order to provide beamforming capability.

UE communication manager 220 handles the communication establishment of the UE to a Radio Access Network, its control and its release. The UE regularly receives from the base station an indication of slots available for communication between the UE and base station. The UE then knows where in time and frequency it expects incoming data or must send its outgoing data, whether they belong to the control or data plane. In an example implementation, the UE communication manager 220 implements the Uu interface.

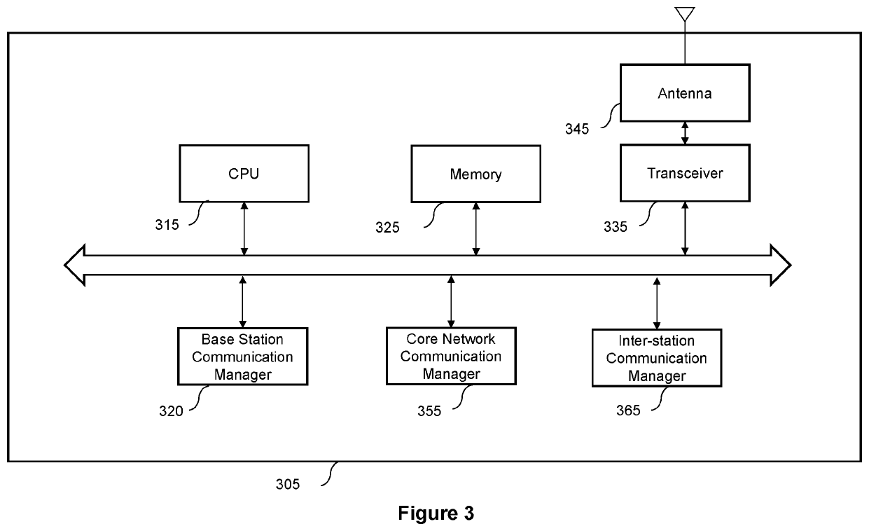

FIG. 3 illustrates a block diagram of a base station device 305, like the base stations or gNBs 110 and 111 in the FIG. 1, in which the present invention may be implemented according to one or more embodiments of the invention. The base station device 305 includes components for transmitting and receiving communications, for example including at least one of a Base Station communication manager 320, a Core Network communication manager 355, a transceiver 335, a set of antennas 345, memory 325, a processor (CPU) 315, and an Inter-Station communication manager 365. All these elements may communicate with each other.

The Base Station communication manager 320 handles the communications with a plurality of UEs. It is responsible for the establishment, the control and the release of these communications. In an example implementation, the Base Station communication manager 320 implements the Uu interface. The Base Station communication manager 320 includes a scheduler that allocates time frequency slots to the different UE communications. Information regarding the schedule of these slots is regularly sent to the involved UEs.

The Core Network communication manager 355 manages communications of the base station with the core network. It may provide a standardized NG interface, as defined by the 3GPP standard, to support these communications.

The transceiver 335 is configured to provide bi-directional wireless communication with other wireless devices. These devices may be UEs, or even other base stations. The transceiver 335 provides the necessary modems and frequency shifters in order to connect to a large number of UEs simultaneously, using different frequency carriers, in Time Division Duplex (TDD) or in Frequency Division Duplex (FDD). The transceiver 335 may include a PDCP transmitter and a PDCP receiver. The PDCP transmitter and the PDCP receiver may be implemented by the processor 315. The PDCP transmitter and the PDCP receiver may be a software only function implemented by the processor 315. The transceiver 335 is connected to the antenna set 345, that may be limited to one antenna, but preferably it contains several antennas, in order to provide beamforming capability.

Memory 325 includes RAM, ROM, or combination of both or as a non-limiting example a mass storage device such as a disk or a Solid-State Drive. BIOS Instructions may be stored within the memory 325 to support an operating system.

The inter-station communication manager 365 manages communications with other base stations. The Inter-Station communication manager 365 may provide a standardized Xn interface, as defined by the 3GPP standard, to support these communications.

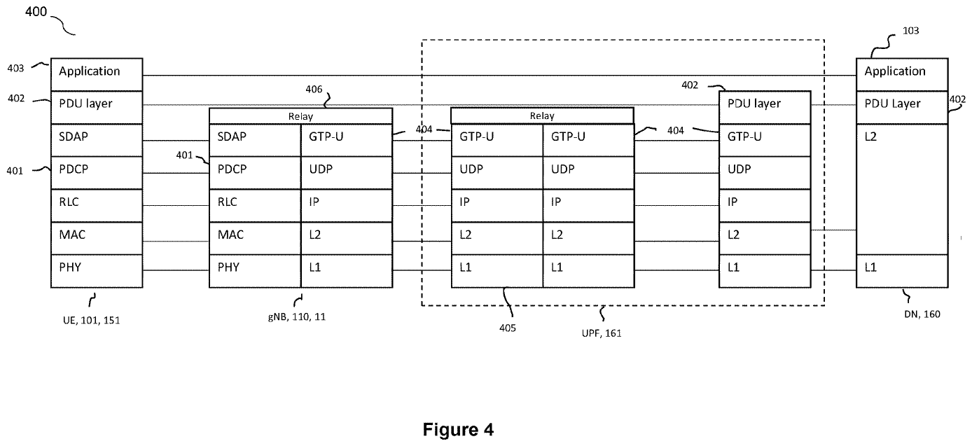

FIG. 4 is a block schematic diagram illustrating the data plane protocol stack of a 5G NR systems as represented in FIG. 1. This data plane protocol stack is described in detail in 3GPP document TS 23.501. In the downlink direction, an application server 103 connects to the UPF (User Plane Function) 161 through a data network 160 at PDU layer 402 level. PDU layer corresponds to the PDUs carried between the UE (user Equipment) and the DN (Data Network) over the PDU Session. When the PDU Session Type is IPv4 or IPv6 or IPv4v6, it corresponds to IPv4 packets or IPv6 packets or both of them; When the PDU Session Type is Ethernet, it corresponds to Ethernet frames; etc. At PDU session establishment time, the core network provides session QoS parameters to UPF, gNB and UE. The PDU session QoS parameters includes the XR PDU Set QoS parameters (S2-2302696):
1. PDU Set Delay Budget.
2. PDU Set Error Rate.
3. PDU Set Integrated Handling Indication. Formerly called PDU Set Integrated Indication

When the PDUs (in the description of FIG. 4, unless stated otherwise, a PDU refers to the packets handled by the PDU layer 402, all other layers handle other types of PDUs and their PDUs will be prefixed by the layer name, e.g. PDCP PDU) arrive at the UPF PDU layer 402, the UPF performs application packets inspection to determine the PDU Set boundaries. Document S2-2302696 provides examples on how to identify PDU Sets when inspecting RTP/SRTP header, RTP header extension, H.264 RTP payload, H.265 RTP payload and H.266 RTP payload.

PDU Set identification information as described in S2-2303842 are determined by UPF and sent to the NG-RAN in the GTP-U header. The PDU Set identification Information comprises:
PDU Set Sequence Number.
Indication of End PDU of the PDU Set
PDU Sequence Number within a PDU Set
PDU Set Size in bytes.
PDU Set Importance, which identifies the relative importance of a PDU Set compared to other PDU Sets within a QoS Flow.

In uplink the application is located on the UE. As explained earlier, the UE obtains the PDU session QoS parameter from the core network when the PDU session is established (PDU session establishment procedure is defined in TS 23.502 clause 4.3.2.). When the PDUs generated by the application 403 arrive at the UE PDU layer 402, the UE performs application packets inspection to determine the PDU Set boundaries in the same way as described earlier for UPF.

In both downlink and uplink, the application 103 sends and receives data to/from the NG-RAN through a GPRs tunnel (GTP-U layer 404, TS 29.281).

In downlink, the UPF detects the PDU Set identification information and obtains from the core network a set of mapping rules (filtering rules). The filtering rules define how each PDU Set is mapped to QoS flows. QoS Flows are identified by an identifier, and GTP-U PDUs are marked according to the determined QoS flow identifier. At the gNB, the relay layer 406 extracts PDU Set identification information and QoS flow identifier from GTP-U PDUs and maps them into SDAP QoS flows. In one XR session, multiple PDU Sets can be mapped to the same QoS flow and also in one XR session, some PDU Sets may be mapped to different QoS flows. Then according to 3GPP document TR-38.835, in one alternative, each SDAP QoS flow can be mapped to a different PDCP DRB (Data Radio Bearer), and in a second alternative, all SDAP QoS flows from the same XR session are mapped to a single PDCP DRB.

In uplink, the UE detects the PDU Set identification information at PDU layer 402, and obtains from the core network a set of mapping rules (filtering rules). The filtering rules define how each PDU Set is mapped to QoS flows. The UE maps the XR PDUs to associated SDAP QoS flows according to the filtering rules. In the same way as for downlink, in uplink, in one XR session, multiple PDU Sets can be mapped to the same QoS flow and, in one XR session, some PDU Sets may be mapped to different QoS flows.

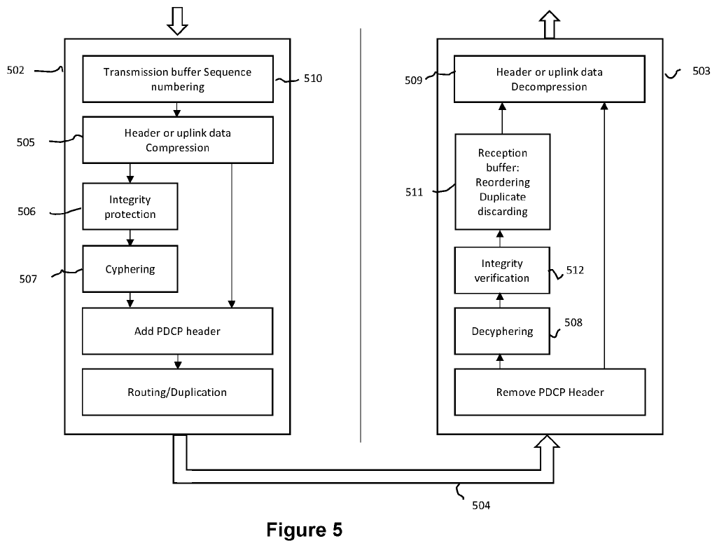

FIG. 5 is a block schematic diagram of an example embodiment of a PDCP protocol layer according to 3GPP document TS 38.323. A PDCP layer 401 is composed of a PDCP transmitting entity 502 and a PDCP receiving entity 503. In this figure, the two PDCP entities do not belong to the same NG-RAN node. The two PDCP entities are connected by radio communication 504 which represents a simplified view on all lower layers from RLC to PHY. For example, PDCP transmitting entity 502 is located on UE 101 and PDCP receiving entity 503 is located on gNB 111. However, the present disclosure is not limited to this particular example, the PDCP transmitting entity (PDCP transmitter) 502 may be located on the gNB 111 and the PDCP receiving entity (PDCP receiver) 503 may be located on the UE 101.

Each NG-RAN node implements both PDCP transmitting and receiving entities, they are not all represented in this figure for simplicity.

Each functional block of the PDCP entities is described in detail in 3GPP document TS 38.323. Each PDCP entity is carrying the data of one radio bearer. A PDCP entity is associated either to the control plane or the user plane depending on which radio bearer it is carrying data for. A PDCP entity associated with DRB/MRB can be configured by RRC layer (TS 38.331, control plane not shown in FIG. 4) to use header compression or uplink data compression (UDC) 505. Robust header compression protocol (ROHC), the Ethernet header compression protocol (EHC) and UDC are supported. Each header compression protocol is independently configured for a DRB/MRB. The compression 505 is performed by the transmitting entity 502, and the decompression 509 is performed by the receiving entity 503.

The integrity protection function includes both integrity protection 506 and integrity verification 512 and is performed in PDCP, if configured by RRC. The data unit that is integrity protected is the PDCP PDU header and the data part of the PDCP PDU before ciphering. The integrity protection is always applied to PDCP Data PDUs of SRBs (Signalling Radio Bearer). The integrity protection is not applicable to PDCP Control PDUs.

The ciphering function includes both ciphering 507 and deciphering 508 and is performed in PDCP, if configured. The data unit that is ciphered is the MAC-I (1203, 1213, 1223) and the data part of the PDCP Data PDU except the SDAP header and the SDAP Control PDU if included in the PDCP SDU (Service Data Unit). The ciphering is not applicable to PDCP Control PDUs.

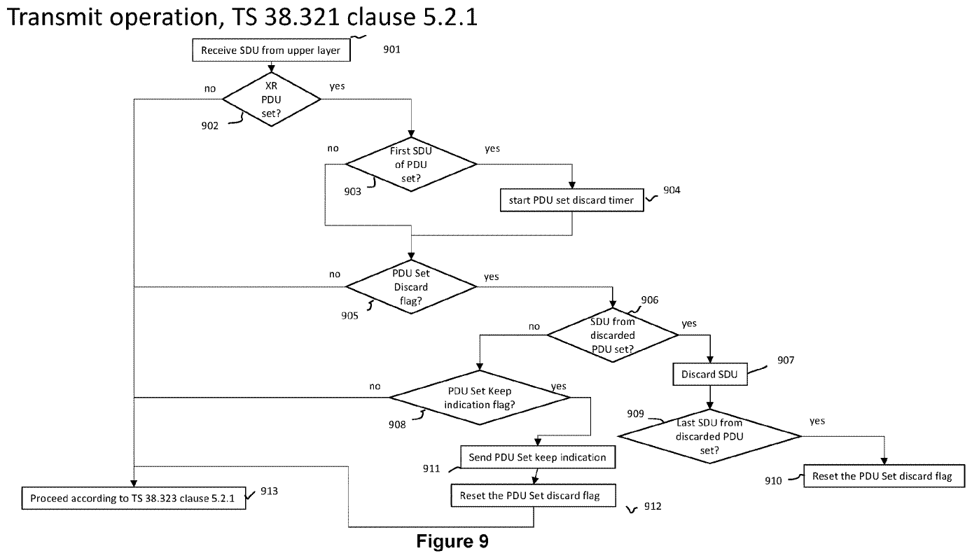

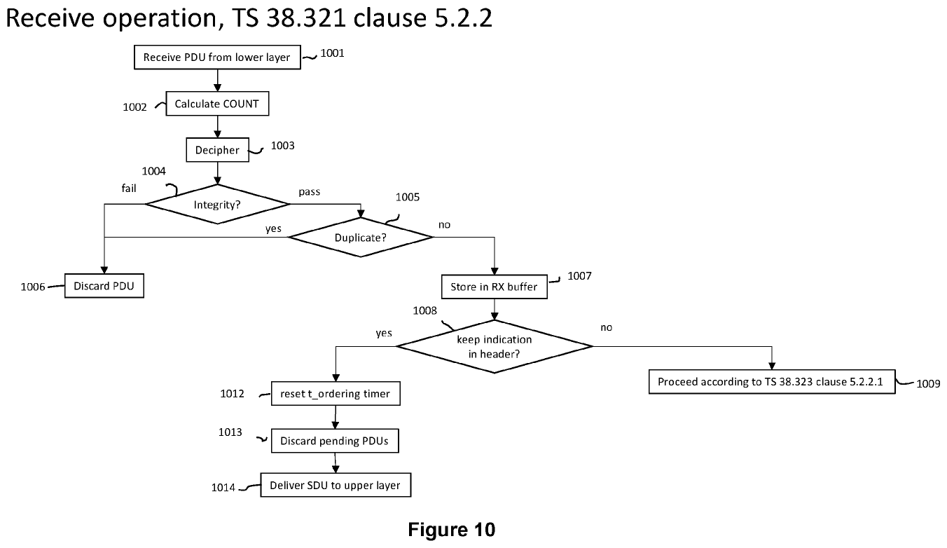

If configured, PDCP transmitting entity 502 performs buffer sequence numbering 510 which is further detailed in FIG. 9, while PDCP receiving entity 503 performs re-ordering and duplication discarding 511 which is further detailed in FIG. 10.

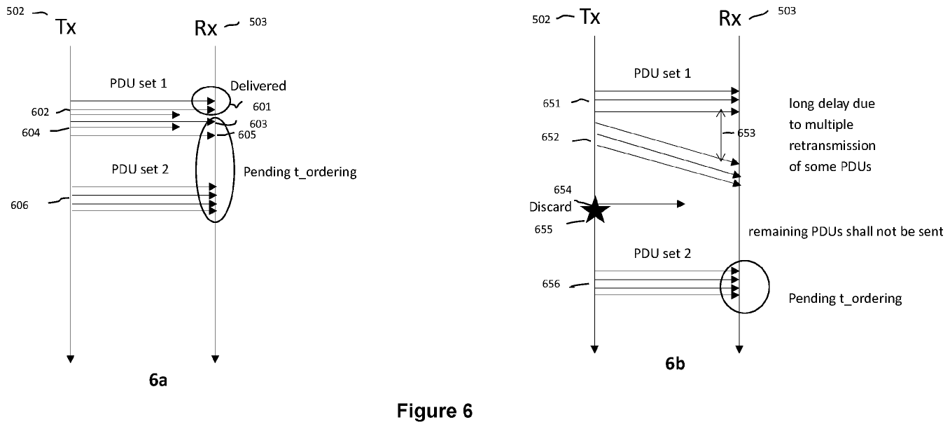

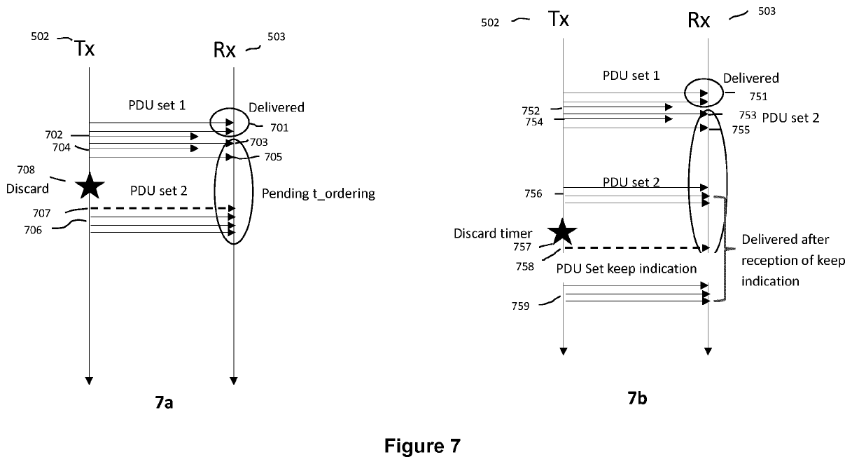

Examples of sequence numbering and re-ordering are given in FIGS. 6a and 6b.

FIG. 6a is a schematic and simplified diagram of an example message flow illustrating the re-ordering function of a PDCP receiving entity according to 3GPP document TS 38.323. It shows a sequence of PDCP PDUs exchanged between a PDCP transmitting entity 502 (for example gNB 111) and a PDCP receiving entity 503 (for example UE 101).

First, two PDCP PDUs 601 are sent in sequence by the PDCP transmitting entity and received in sequence by the PDCP receiving entity. These two PDCP PDUs are delivered to higher layers (SDAP layer). Then third PDCP PDU is sent by PDCP transmitting entity but not received by PDCP receiving entity. This can be due to bad radio link conditions. Lower layers like RLC and MAC performs, if configured, multiple retransmission of the PDCP PDU 602. While lower layers handle the retransmission of PDCP PDU 602, PDCP transmitting entity sends the fourth PDCP PDU 603. The PDCP receiving entity receives the PDCP PDU 603 and detects missing PDCP PDU 602 as there is a sequence gap between PDCP PDUs 601 and PDCP PDU 603. PDCP receiving entity stores PDCP PDU 603 and starts t_ordering timer. PDCP PDU 603 will not be delivered to upper layer (SDAP) until either PDCP PDU 602 is received or t_ordering timer elapses. PDCP PDU 604 is sent by PDCP transmitting entity but not received by PDCP receiving entity. PDCP transmitting entity sends PDCP PDU 605, received by the PDCP receiving which detects missing PDCP PDU 604 as there is a sequence gap between PDCP PDU 603 and PDCP PDU 605. PDCP receiving entity stores PDCP PDU 605 while t_ordering timer is already running. PDCP PDU 605 will not be delivered to upper layer (SDAP) until PDCP PDUs 603 is delivered and PDCP PDU 604 is received or t_ordering timer elapses after being re-initialised when PDU 603 is delivered. PDCP transmitter then sends a set of PDCP PDUs 606. PDCP receiving entity stores PDCP PDUs 606 while t_ordering timer is already running. PDCP PDUs 606 will not be delivered to upper layer (SDAP) until PDCP PDUs 605 is delivered. PDCP PDU 605 is pending PDCP PDU 603 delivery and PDCP PDU 604 reception or t_ordering timer elapses after being re-initialised when PDU 603 is delivered. PDCP PDU reception refers to reception by the PDCP receiving entity whereas PDCP PDU delivery refers to delivery to higher layers (SDAP layer) by the PDCP receiving entity. When discarding PDUs with already assigned SN, the PDCP transmitting entity shall signal the discard operation to the remote PDCP receiving entity.

In this example, PDCP PDUs 601 to 605 are part of PDU Set 1 and PDUs 606 are part of PDU Set 2. The PDU Set identification information are known at transmitting side SDAP layer and not known at receiving side.

In this example, PDCP receiving entity will delay the delivery of PDU Set 2 at least until PDCP PDUs 602 and 604 are received and in the worst case, PDU Set 2 delivery is delayed by the duration of t_ordering timer duration if PDCP PDU 602 is received and PDCP PDU 604 is lost.

The worst case scenario is more likely to happen if a PDU Set discard condition is triggered on the transmitting side while PDCP PDUs 602 and 604 are already sent to lower layers. In that case, lower layer retransmission of these PDCP PDUs are stopped, thus highly increasing the probability that they are never received at the receiving entity.

FIG. 6b is a schematic and simplified diagram of another example message flow illustrating the re-ordering function of a PDCP receiving entity according to 3GPP document TS 38.323.

A first set of PDCP PDUs 651 is sent in sequence by the PDCP transmitting entity and received in sequence by the PDCP receiving entity. These three PDCP PDUs are delivered to high layers (SDAP layer). Then three other PDCP PDUs 652 are sent by PDCP transmitting entity but due to bad radio link conditions, lower layers like RLC and MAC performed multiple retransmission of the PDCP PDUs 652 until reception by the receiving entity. These multiple retransmissions induced a considerable delay 653 between the reception of the first PDCP PDUs 615 and the PDCP PDUs 652. Then almost simultaneously, PDCP transmitting entity sends another PDCP PDU 654, and detects a PDU Set discard condition 655 based on the PDU Set Delay Budget QoS parameter. The PDU Set delay budget is elapsed because of the retransmission delay 653. The PDCP PDU 654 transmission is discarded by lower layer following actions due to PDU Set discarding.

Later the PDCP transmitting entity starts sending PDCP PDUs 656 related to a second PDU Set. At the receiving entity, PDCP PDUs 656 are received and PDCP PDU 654 is detected as missing. Indeed, there is a sequence number gap between PDCP PDUs 652 and PDCP PDUs 656. PDCP receiving entity stores PDCP PDUs 656 and starts t_ordering timer. PDCP PDU 656 will not be delivered to upper layer (SDAP) until either PDCP PDU 654 is received or t_ordering timer elapses.

FIG. 7a is a schematic and simplified diagram of an example message flow illustrating the re-ordering function of a PDCP receiving entity according to a first embodiment of the invention.

The example depicted in FIG. 7a can be applied to solve both FIG. 6a and FIG. 6b issues. It shows a sequence of PDCP PDUs exchanged between a PDCP transmitting entity 502 (for example gNB 111) and a PDCP receiving entity 503 (for example UE 101).

First, two PDCP PDUs 701 are sent in sequence by the PDCP transmitting entity and received in sequence by the PDCP receiving entity. These two PDCP PDUs are delivered to high layers (SDAP layer). Then third PDCP PDU 702 is sent by PDCP transmitting entity but not received by PDCP receiving entity. This can be due to bad radio link conditions. Lower layers like RLC and MAC perform, if configured, multiple retransmissions of the PDCP PDU 702. While lower layers handle the retransmission of PDCP PDU 702, PDCP transmitting entity sends the fourth PDCP PDU 703. The PDCP receiving entity receives the PDCP PDU 703 and detects missing PDCP PDU 702 as there is a sequence gap between PDCP PDUs 701 and PDCP PDU 703. PDCP receiving entity stores PDCP PDU 703 and starts t_ordering timer. PDCP PDU 704 is sent by PDCP transmitting entity but not received by PDCP receiving entity. PDCP transmitting entity sends PDCP PDU 705, received by the PDCP receiving which detects missing PDCP PDU 704 as there is a sequence gap between PDCP PDU 703 and PDCP PDU 705. PDCP receiving entity stores PDCP PDU 705 while t_ordering timer is already running. PDCP PDUs 701-705 belong to a first PDU Set.

Then PDCP transmitting entity detects a PDU Set discard condition 708 based on the first PDU Set “PDU Set Delay Budget” QoS parameter. The PDCP PDU 704 transmission is discarded by lower layer following actions due to PDU Set discarding.

The PDCP transmitting entity sends a “PDU Set Keep Indication” 707 to the PDCP receiving entity.

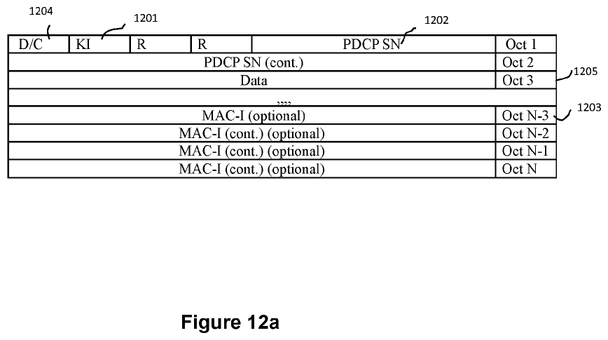

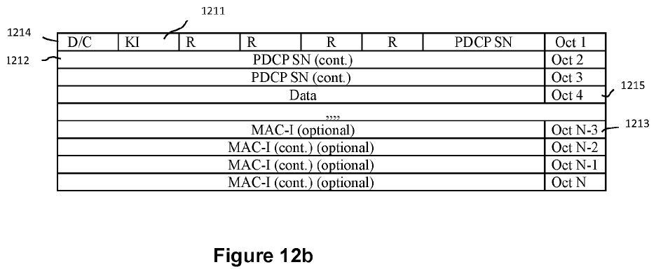

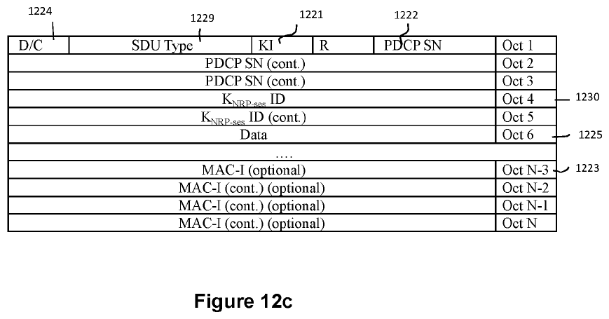

If the next PDU Set PDCP PDUs 706 are ready to be sent, the “PDU Set Keep Indication” can be one bit in the header of the first PDCP PDU of 706 (FIGS. 12a-12c).

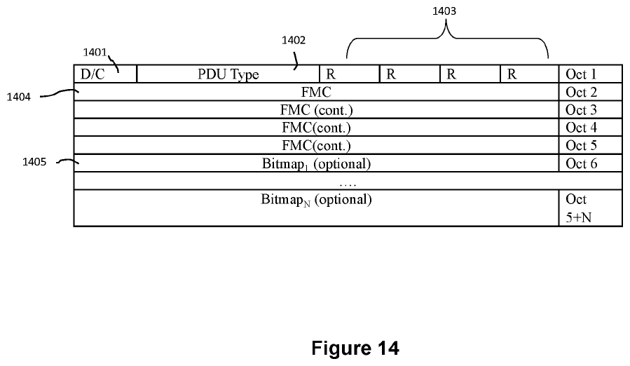

Also the “PDU Set Keep Indication” can be a control PDCP PDU (FIG. 14) with FMC (First Missing COUNT) field set to the sequence number of the first PDCP PDU of 706 and no Bitmap.

If the next PDU Set of PDCP PDUs 706 are not ready to be sent then the “PDU Set Keep Indication” can be a control PDCP PDU (FIG. 14) with FMC field set to the sequence number of the PDCP PDU 705 incremented by one and no Bitmap.

When receiving the “PDU Set Keep Indication” 707, the PDCP receiving entity may reset the t_ordering timer, discard pending PDCP PDUs 702, 704 and deliver the received PDCP PDU 703, 705 to upper layer.

Resetting the t_ordering timer refers to stopping the timer and setting the timer to its initial value.

PDCP PDU 703 and 705 might also be discarded, but since it is already received, the behaviour can be left to some configuration of the PDCP receiving entity.

The “PDU Set Keep Indication” may be transmitted in the first PDCP PDU of PDCP PDUs 706 depending on whether a “PDU Set Keep Indication Flag” is set in the PDCP transmitter in the above example. It is to be understood that “PDU Set Keep Indication” is a term used to refer to an indicator sent from a PDCP transmitter to a PDCP receiver, and the function and structure of the indicator is as described in the present disclosure. Similarly, it is to be understood that the “PDU Set Keep Indication Flag” is a term used to refer to an indication flag configured in the PDCP transmitter, and the function of the indicator flag is as described in the present disclosure.

FIG. 7b is a schematic and simplified diagram of another example message flow illustrating the re-ordering function of a PDCP receiving entity according to a second embodiment of the invention.

The example depicted in FIG. 7b can be applied in case PDU Sets of PDCP PDUs are interleaved in the PDCP transmitter entity. It shows a sequence of PDCP PDUs exchanged between a PDCP transmitting entity 502 (for example gNB 111) and a PDCP receiving entity 503 (for example UE 101).

First, two PDCP PDUs 751 are sent in sequence by the PDCP transmitting entity and received in sequence by the PDCP receiving entity. These two PDCP PDUs are delivered to high layers (SDAP layer). Then third PDCP PDU 752 is sent by PDCP transmitting entity but not received by PDCP receiving entity. This can be due to bad radio link conditions. Lower layers like RLC and MAC perform, if configured, multiple retransmissions of the PDCP PDU 752. While lower layers handle the retransmission of PDCP PDU 752, PDCP transmitting entity sends the fourth PDCP PDU 753. The PDCP receiving entity receives the PDCP PDU 753 and detects missing PDCP PDU 752 as there is a sequence gap between PDCP PDUs 751 and PDCP PDU 753. PDCP receiving entity stores PDCP PDU 753 and starts t_ordering timer. PDCP PDU 754 is sent by PDCP transmitting entity but not received by PDCP receiving entity. PDCP transmitting entity sends PDCP PDU 755, received by the PDCP receiving which detects missing PDCP PDU 754 as there is a sequence gap between PDCP PDU 753 and PDCP PDU 755. PDCP receiving entity stores PDCP PDU 755 while t_ordering timer is already running. PDCP PDUs 751, 752, 754 and 755 belong to a first PDU Set and PDCP PDU 753 belongs to a second PDU Set.

Next PDCP transmitting entity transmits PDCP PDUs 756 belonging to the second PDU Set. PDCP receiving entity receives and stores PDCP PDUs 756.

Until now, the delivery of second PDU Set is pending reception of PDCP PDU 752 which is blocking the delivery of PDCP PDU 753.

Then PDCP transmitting entity detects a PDU Set discard condition 757 based on the first PDU Set “PDU Set Delay Budget” QoS parameter. The PDCP PDU 752 and 754 transmission are discarded by lower layer following actions due to PDU Set discarding.

The PDCP transmitting entity sends a “PDU Set Keep Indication” 758 to the PDCP receiving entity.

Since two PDU Sets are interleaved, the PDCP transmitter cannot send a one bit version of “PDU Set Keep Indication”. First PDCP PDU of second PDU Set is PDCP PDU 753 and shall be kept, while PDCP PDU 754 shall be discarded.

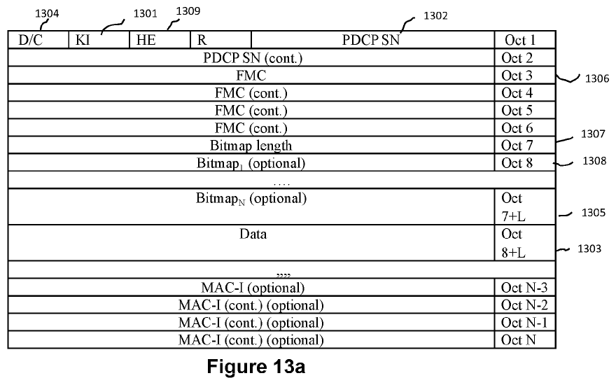

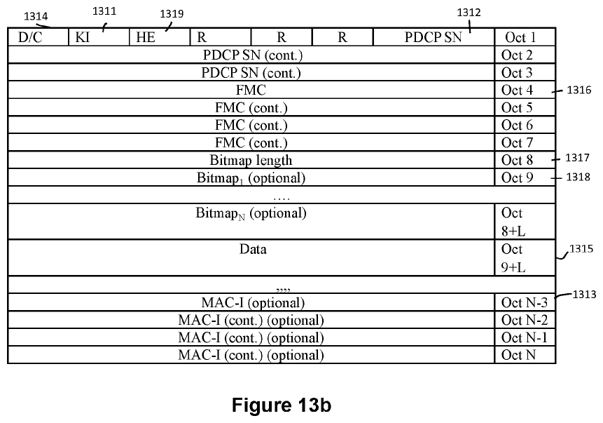

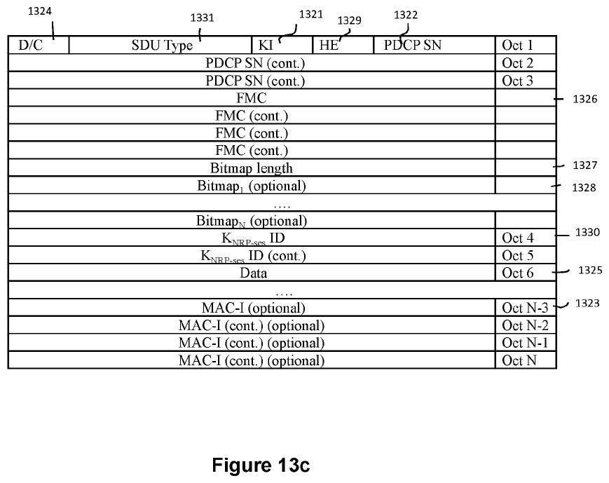

So, if the next PDU Set of PDCP PDUs 759 are ready to be sent, the “PDU Set Keep Indication” can be a header extension in the header of the first PDCP PDU of PDCP PDUs 759 (FIGS. 13a-13c). The FMC field shall be set to the sequence number of the PDCP PDU 753 and the Bitmap Field shall indicate to discard PDCP PDUs 754, 755 and keep PDCP PDUs 756 (0,0,1,1,1). The Bitmap length field is set to 5. The FMC field indicates that PDCP PDU 753 is the first PDCP PDU to keep, so the Bitmap field may start from PDCP PDU 754.

Also the “PDU Set Keep Indication” can be a control PDCP PDU (FIG. 14) with the FMC field set to the sequence number of the PDCP PDU 753 and the Bitmap Field shall indicate to discard PDCP PDUs 754, 755 and keep PDCP PDUs 756 (0,0,1,1,1).

If the next PDU Set of PDCP PDUs 759 are not ready to be sent then the “PDU Set Keep Indication” can be a control PDCP PDU (FIG. 14) with FMC field set to the sequence number of the PDCP PDU 753 and the Bitmap Field shall indicate to discard PDCP PDUs 754, 755 and keep PDCP PDUs 756 (0,0,1,1,1).

When receiving the “PDU Set Keep Indication” 758, the PDCP receiving entity may reset the t_ordering timer, discard pending PDCP PDUs 752, 754 and deliver the received PDCP PDUs 753, 755, 756 to upper layer.

PDCP PDU 755 might also be discarded, but since it is already received, the behaviour can be left to some configuration of the PDCP receiving entity.

The “PDU Set Keep Indication” may be transmitted in the first PDCP PDU of PDCP PDUs 759 depending on whether a “PDU Set Keep Indication Flag” is set in the PDCP transmitter in the above example. It is to be understood that “PDU Set Keep Indication” is a term used to refer to an indicator sent from a PDCP transmitter to a PDCP receiver, and the function and structure of the indicator is as described in the present disclosure. Similarly, it is to be understood that the “PDU Set Keep Indication Flag” is a term used to refer to an indication flag configured in the PDCP transmitter, and the function of the indicator flag is as described in the present disclosure.

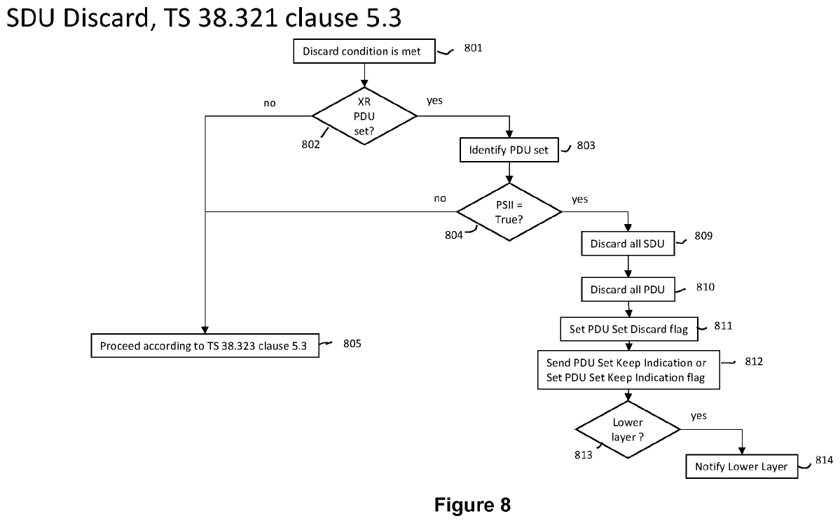

FIG. 8 is a flow chart illustrating an example method executed by a PDCP transmitting entity (PDCP transmitter) for handling a PDU discard condition according to an embodiment of the invention. The flow chart may be implemented in the PDCP function “Transmission buffer Sequence numbering” 510, executed by CPU 215 for a UE, or on CPU 315 for a gNB.

At step 801, a PDU Set discard condition is detected among at least one of the following conditions:
A PDU discard timer elapsed for a PDCP PDU (faulty PDU),
A PDU Set discard timer elapsed,
A status report is received from receiving PDCP entity indicating that a PDCP PDU of a first PDCP PDU Set is not received and optionally that the RLC layer and MAC layer are not retransmitting this PDU (faulty PDU). PDU Set Discard timer and PDU discard timer initialisation is described in FIG. 9. PDU Discard timer is started each time a new SDU is received by the PDCP transmitter from an upper layer (SDAP). PDU Set Discard timer is started when a first SDU of a PDU Set is received by the PDCP transmitter from an upper layer (SDAP). PDCP status reporting is described in 3GPP document 38.323, clause 5.4.

At test 802, the transmitting PDCP entity may check if the faulty PDU is part of an XR PDU Set. This information is obtained from the SDAP layer. This test is not executed in case a PDU Set discard timer is used.

If the faulty PDU is not part of an XR PDU Set (no to 802), then during step 805 the PDCP transmitting entity handles the faulty PDU as instructed in 3GPP document TS 38.323, clause 5.3 by discarding the associated PDCP SDU, discarding the PDCP PDU and notifying the lower layer if the PDCP PDU has been already sent to it. As a result, the lower layer should discard any on-going transmission of the faulty PDCP PDU.

If the faulty PDCP PDU is part of an XR PDU Set then during step 803, the corresponding PDU Set is identified thanks to SDAP PDU Set identification information “PDU Set Sequence Number”.

Then during test 804, PSIHI (or PSII) PDU Set QoS parameter is checked. PSIHI (or PSII) stands for PDU Set Handling Integrated Indication (PDU Set Integrated Indication) and is part of the QoS parameters obtained by SDAP layer at session establishment. PSI and PSIHI refers to the same parameter, during the rest of this document we will use PSIHI. If the value of PSIHI is “false” (no to 804) then the PDU Set shall not be discarded because of one faulty PDCP PDU, so only the faulty PDCP PDU is discarded during step 805.

When using a PDU Set discard timer, a faulty PDU is not identified and PSIHI is supposed to be true.

If PSIHI is true (yes to 804) then all PDCP PDUs belonging to the same PDU Set as the faulty PDU (respectively all PDCP PDUs belonging to the PDU Set identified by the PDU Set discard timer) shall be discarded during steps 809 and 810. The discarded PDU Set is identified thanks to the “PDU Set Sequence Number” obtained during step 803.

During step 809 all PDCP SDUs belonging to the “PDU Set Sequence Number” are discarded. The packets delivered by SDAP layer are called SDAP PDUs or a PDCP SDUs. That is, when PDCP transmitter 502 associates a sequence number (see block 510 from FIG. 5) to the PDCP SDU, the PDCP SDU becomes a PDCP PDU. More generally, the PDCP SDU is converted into a PDCP PDU by applying the layer specific header to the PDCP SDU.

During step 810, all PDCP PDUs belonging to the “PDU Set Sequence Number” are discarded.

Note that during step 809, only the SDUs already sent to the PDCP transmitter by the SDAP layer are discarded. Other SDUs belonging to the same “PDU Set Sequence Number” can be sent by the SDAP layer to the PDCP transmitter after step 809. For this, the PDCP transmitting entity sets a PDU Set Discard flag associated to the “PDU Set Sequence Number” during step 811.

Step 812 has different alternatives.

In a first embodiment, during step 812, the PDCP transmitting entity sends a “PDU Set Keep Indication” to the PDCP receiving entity not in a PDCP PDU. In this way, the keep indication is sent earlier than the following PDCP PDU and the PDCP receiving entity gets more time to handle the past PDCP PDUs. In this embodiment the “PDU Set Keep Indication” can be formatted as a control PDU, described further in FIG. 14.

In another embodiment during step 812, the PDCP transmitting entity sets a “PDU Set Keep Indication ‘flag’”, so that a “PDU Set Keep Indication” is sent when a PDCP PDU belonging to another PDU Set is ready to be sent (FIG. 9). In this way the “PDU Set Keep Indication” can be inserted in a PDCP data PDU saving the overhead of sending a dedicated control PDU. In this embodiment the “PDU Set Keep Indication” can be formatted as described further in FIGS. 12a-12c, 13a, 13b, 13c and 14 (Formatting as shown in FIG. 14 is possible but without the advantage).

The decision about the two alternatives for step 812 can be decided during operation, for example, the PDCP transmitting entity will set the PDU Set Keep Indication flag so that a “PDU Set Keep Indication” is sent when a PDCP PDU belonging to another PDU Set is ready to be sent if the PDU Sets are not interleaved. If the PDU Set Keep Indication is sent to the PDCP receiving entity not in a PDCP PDU of application data, then there is no need to set the PDU Set Keep Indication flag.

For all PDCP PDUs discarded during step 810, if some of them have been already sent to lower layer (RLC) (yes to test 813), the PDCP transmitting entity may notify the lower layer which should discard any on-going transmission of the discarded PDCP PDUs.

FIG. 9 is a flow chart illustrating an example method executed by a PDCP transmitting entity (PDCP transmitter) for PDU transmission according to an embodiment of the invention. The flow chart may be implemented in the PDCP function “Transmission buffer Sequence numbering” 510, executed by CPU 215 for a UE, or on CPU 315 for a gNB. The method of FIG. 8 may be triggered when a discard condition is met. The method of FIG. 9 may be triggered when a new SDU is provided by upper layer (SDAP) for transmission to the PDCP receiver. The methods of FIGS. 8 and 9 may both be performed by the same PDCP transmitter. For example, the method of FIG. 8 may set the PDU Discard flag and may set the PDU Set Keep Indication flag which influence the method of FIG. 9. The method of FIG. 9 may reset the PDU Discard flag and may reset the PDU Set Keep Indication flag. The method of either FIG. 8 or FIG. 9 may result in the PDU Set Keep Indication being sent to the PDCP receiver from the PDCP transmitter.

During step 901 the PDCP transmitting entity receives a PDCP SDU from higher layer (SDAP), which may be an example of first information of the application data.

During step 902 the PDCP transmitting entity may check with the SDAP layer if the PDCP SDU belongs to an XR PDU Set.

If the PDCP SDU does not belong to a XR PDU Set (no to 902) then during step 913, the SDU is handled for transmission as instructed in 3GPP document TS 38.823, clause 5.2.1.

Otherwise, if the PDCP SDU of the first received SDU belongs to a given PDU Set (the PDU Set is identified by “PDU Set Sequence Number”) (yes to 903) then during step 904 a “PDU Set discard timer” is started. The initialisation value of the timer can be linked to QoS parameter “PDU Set Delay Budget”, or it can be defined by configuration, for example if the PDCP transmitting entity is run by a UE, the value can be configured by the gNB by dedicated signalling (e.g. RRC).

Alternatively, if the PDCP transmitting entity is not configured to use the PDU Set discard timer then it shall set a PDU discard timer to each incoming SDU. For all SDUs belonging to a given PDU Set, the PDU discard timer of the first received SDU shall be linked to QoS parameter “PDU Set Delay Budget”, and all subsequent received SDUs from the same PDU Set shall have their PDU discard timer linked to both QoS parameter “PDU Set Delay Budget” and arrival time difference with the first SDU. PDU discard timer initialization value can also be defined by configuration, for example if the PDCP transmitting entity is run by a UE, the value can be configured by the gNB by dedicated signalling (e.g. RRC).

Then during test 905, the PDCP transmitting entity checks whether there is a “PDU Set Discard” flag for any PDU Set. In case there are no “PDU Set discard” flag (no to 905), it means that the current transmission can proceed normally and that no “PDU Set Keep Indication” shall be transmitted. Then, during step 913, the SDU is handled for transmission as instructed in 3GPP document TS 38.823, clause 5.2.1.

If at least one “PDU Set Discard” flag is set (yes to 905) then in test 906, the PDCP transmitting entity checks if the received SDU belongs to the PDU Set flagged to be discarded.

If the received SDU belongs to the PDU Set flagged to be discarded (yes to 906), then during step 907, the received SDU is discarded. If the discarded SDU was the last SDU received from the PDU Set flagged for discard (yes to 909) then the associated “PDU Set Discard” flag is reset.

If the received SDU does not belong to the PDU Set flagged to be discarded (no to 906), then the PDCP transmitting entity checks if the “PDU Set Keep indication” flag is set. For example, set during the method of FIG. 8.

If “PDU Set Keep indication” flag is not set (no to 908) then, during step 913, the SDU is handled for transmission as instructed in 3GPP document TS 38.823, clause 5.2.1.

If “PDU Set Keep indication” flag is set (yes to 908) then, during step 911 the PDCP transmitting entity sends a “PDU Set Keep indication”. “PDU Set Keep Indication” can be formatted as:
One bit in the data PDCP PDU (FIGS. 12a, 12b, 12c) built from the received PDCP SDU,
A PDCP control PDU sent before the data PDCP PDU built from the received PDCP SDU (FIG. 14), or
Additional header in the data PDCP PDU built from the received PDCP SDU (FIGS. 13a, 13b, 13c).

The format of the PDU Set Keep Indication may be determined by configuration of the PDCP transmitter.

Then the PDCP SDU (including the modified header if any) is handled for transmission as instructed in 3GPP document TS 38.823, clause 5.2.1.

FIG. 10 is a flow chart illustrating an example method executed by a PDCP receiving entity (PDCP receiver) for PDU reception according to an embodiment of the invention. The flow chart may be implemented in the PDCP function “Reception buffer: Reordering Duplicate discarding” 511, executed by CPU 215 for a UE, or on CPU 315 for a gNB.

In step 1001, the PDCP receiving entity receives a PDCP PDU from lower layer (RLC).

In step 1002, the PDCP receiving entity calculates the PDCP PDU sequence number as a combination of PDCP SN header field and HFN (Hyper Frame Number). Details described in 3GPP document TS 38.323, clause 5.2.2.1.

Then, if configured, the data part of the PDCP PDU is deciphered in step 1003.

Then the integrity of the PDCP PDU is checked in test 1004. If the integrity check fails (no to 1004), then the received PDCP PDU is discarded.

If the integrity check passes (yes to 1004), but if the received PDCP PDU is a duplicate of already delivered PDCP PDU (yes, to 1005), the received PDCP PDU is discarded.

Otherwise, the received PDCP PDU is stored in memory buffer during step 1007.

In test 1008, the header of the received PDCP PDU is checked for keep indication (KI). If there is no keep indication in the header (no to 1008), then PDCP receiving entity, during step 1009, proceeds with the received PDCP PDU as described in 3GPP document TS 38.323, clause 5.2.2.1.

If there is the keep indication in the header (yes to 1008), then PDCP receiving entity, in step 1012, shall reset the t_ordering timer if it was running.

Then in step 1013, the PDCP receiving entity shall discard all pending PDCP PDUs prior to the received PDCP PDU.

Then in step 1014, the PDCP receiving entity shall deliver the received PDCP PDU to upper layer as a PDCP SDU.

Alternatively if the header contains more than the KI bit (means it include additional header with FMC (First Missing COUNT) and Bitmap as described in FIGS. 13a-13c), the PDCP receiving entity, shall reset the t_ordering timer if it was running and the bitmap field does not indicate to keep a PDU with lower sequence number than the FMC field that has not yet been received. Or to put it in another way, the PDCP receiving entity shall reset the t_ordering timer if it was running and all the PDCP PDUs with a keep indication in the bitmap field have already been received.

Then the receiving PDCP entity shall discard all pending PDCP PDUs prior to the FMC sequence number, that are not set to keep in the Bitmap field.

Then the PDCP receiving entity recalculates the sequence of prior pending PDUs taking into account the discarded PDUs as reported in the Bitmap field. Then PDCP receiving entity shall deliver the prior pending PDCP PDU (with sequence number less than FMC) that are not out of sequence.

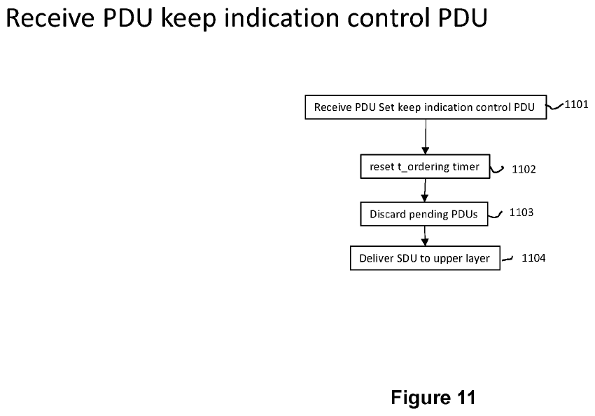

FIG. 11 is a flow chart illustrating an example method executed by a PDCP receiving entity (PDCP receiver) for PDU Set Keep Indication control PDU reception according to an embodiment of the invention. The flow chart may be implemented in the PDCP function “Reception buffer: Reordering Duplicate discarding” 511, executed by CPU 215 for a UE, or on CPU 315 for a gNB.

In step 1101, the receiving PDCP entity receives a “PDU Set Keep Indication” in a control PDU (FIG. 14).

The PDCP receiving entity, in step 1102, shall reset the t_ordering timer if it was running and the bitmap field does not indicate to keep a PDU with lower sequence number than the FMC field that has not yet been received. Or to put it in another way, the PDCP receiving entity shall reset the t_ordering timer if it was running and all the PDCP PDUs with a keep indication in the bitmap field have already been received.

Then in step 1103, the PDCP receiving entity shall discard all pending PDCP PDUs prior to the FMC sequence number, that are not set to keep in the Bitmap field. The PDCP receiving entity may discard pending PDUs stored in the memory buffer not indicated by the PDU Set Keep Indication.

Then in step 1104, the PDCP receiving entity recalculates the sequence of prior pending PDUs taking into account the discarded PDUs as reported in the Bitmap field. Then PDCP receiving entity shall deliver the prior pending PDCP PDU (with sequence number less than FMC) that are not out of sequence.

FIG. 12a is a block schematic diagram illustrating a PDCP Data PDU for DRBs and MRBs with 12 bits PDCP SN, which is an example of a PDU of application data, according to an embodiment of the invention.

In this embodiment the PDU Set Keep Indication is implemented by a single bit information in the header of the PDCP Data PDU. The PDCP Data PDU is an example of a PDU of application data.

“PDU Set Keep Indication” is implemented in the KI bit 1201 of a Data PDU for DRBs and MRBs with 12 bits PDCP SN. If the PDU Set Keep Indication is set to “0”, then no action is expected from the PDCP receiving entity and if PDU Set Keep Indication is set to “1”, it indicates that the PDCP Sequence Number (PDCP SN) 1202 represents the first PDCP PDU to keep, PDUs with lower sequence number shall be discarded. For instance, the first PDCP PDU to keep is the PDCP PDU contained in this packet which may be the first PDU of an application data packet.

Other fields of the PDCP PDU are explained in 3GPP document TS 38.323, clause 6.2.2.2. D/C field 1204 must be set to “D” for data. Data field 1205 contains uncompressed PDCP SDU or compressed PDCP SDU. MAC-I field 1203 carries a message authentication code.

FIG. 12b is a block schematic diagram illustrating a PDCP Data PDU for DRBs and MRBs with 18 bits PDCP SN, which is an example of a PDU of application data, according to an embodiment of the invention.

In this embodiment, the PDU Set Keep Indication is implemented by a single bit information in the header of the PDCP Data PDU. The PDCP Data PDU is an example of a PDU of application data.

“PDU Set Keep Indication” is implemented in the KI bit 1211 of a Data PDU for DRBs and MRBs with 18 bits PDCP SN. If the PDU Set Keep Indication is set to “0”, then no action is expected from the PDCP receiving entity and if PDU Set Keep Indication is set to “1”, it indicates that the PDCP Sequence Number (PDCP SN) 1212 represents the first PDCP PDU to keep, PDUs with lower sequence number shall be discarded. For instance, the first PDCP PDU to keep is the PDCP PDU contained in this packet which may be the first PDU of an application data packet.

Other fields of the PDCP PDU are explained in 3GPP document TS 38.323, clause 6.2.2.3. D/C field 1214 must be set to “D” for data. Data field 1215 contains uncompressed PDCP SDU or compressed PDCP SDU. MAC-I field 1213 carries a message authentication code.

FIG. 12c is a block schematic diagram illustrating a PDCP Data PDU for sidelink DRBs for unicast with 18 bits PDCP SN, which is an example of a PDU of application data, according to an embodiment of the invention.

In this embodiment the PDU Set Keep Indication is implemented by a single bit information in the header of the PDCP Data PDU. The PDCP Data PDU is an example of a PDU of application data.

PDU Set Keep Indication is implemented in the KI bit 1221 of a Data PDU for sidelink DRBs for unicast with 18 bits PDCP SN.

If the PDU Set Keep Indication is set to “0”, then no action is expected from the PDCP receiving entity and if PDU Set Keep Indication is set to “1”, it indicates that the PDCP Sequence Number (PDCP SN) 1222 represents the first PDCP PDU to keep, PDUs with lower sequence number shall be discarded. For instance, the first PDCP PDU to keep is the PDCP PDU contained in this packet which may be the first PDU of an application data packet.

Other fields of the PDCP PDU are explained in 3GPP document TS 38.323, clause 6.2.2.7. D/C field 1224 must be set to “D” for data. Data field 1225 contains uncompressed PDCP SDU or compressed PDCP SDU. MAC-I field 1223 carries a message authentication code. SDU type field 1229 can be IP, Non-IP, Ethernet, Unstructured or ARP. KNRP field 1230 is an Identity as specified in TS 33.536.

In other words, the PDU Set Keep Indication being implemented by a single bit refers to the PDU Set Keep Indication adding a single bit to the data of a PDU of application data to minimise overhead.

FIG. 13a is a block schematic diagram illustrating a PDCP Data PDU for DRBs and MRBs with 12 bits PDCP SN, which is an example of a PDU of application data, according to an embodiment of the invention.

In this embodiment, the PDU Set Keep Indication is implemented by a header extension, flagged by HE bit 1309. The header extension contains:
The FMC field 1306 is 32 bits wide and contain the COUNT value of a PDCP SDU to keep. Alternatively, the FMC field 1306 may contain the COUNT value of a first PDCP PDU to discard. COUNT is defined in TS 38.323, clause 6.3.5 as “The COUNT value is composed of a HFN and the PDCP SN. The size of the HFN part in bits is equal to 32 minus the length of the PDCP SN”. FMC field is optional and can be replaced by PDCP SN field 1302. PDCP SN field 1302 contains the PDCP sequence number of this PDCP PDU.
The bitmap length field 1307 provides the length of the bitmap field.
The bitmap field 1308 has a variable length. This field indicates which SDUs can be discarded and which SDUs must be kept by the PDCP receiving entity. The bit position of Nth bit in the Bitmap is N, i.e., the bit position of the first bit in the Bitmap is 1.

Other fields of the PDCP PDU are explained in 3GPP document TS 38.323, clause 6.2.2.2. D/C field 1304 must be set to “D” for data. Data field 1305 contains uncompressed PDCP SDU or compressed PDCP SDU. MAC-I field 1303 carries a message authentication code.

FIG. 13b is a block schematic diagram illustrating a PDCP Data PDU for DRBs and MRBs with 18 bits PDCP SN, which is an example of a PDU of application data, according to an embodiment of the invention.

In this embodiment, the PDU Set Keep Indication is implemented by a header extension, flagged by HE bit 1319. The header extension contains:
The FMC field 1316 is 32 bits wide and contain the COUNT value of a PDCP SDU to keep. Alternatively, the FMC field 1306 may contain the COUNT value of a first PDCP PDU to discard. COUNT is defined in TS 38.323, clause 6.3.5 as “The COUNT value is composed of a HFN and the PDCP SN. The size of the HFN part in bits is equal to 32 minus the length of the PDCP SN”. FMC field is optional and can be replaced by PDCP SN field 1312. PDCP SN field 1312 contains the PDCP sequence number of this PDCP PDU.
The bitmap length field 1317 provides the length of the bitmap field.
The bitmap field 1318 has a variable length. This field indicates which SDUs can be discarded and which SDUs must be kept by the receiving PDCP entity. The bit position of Nth bit in the Bitmap is N, i.e., the bit position of the first bit in the Bitmap is 1.

Other fields of the PDCP PDU are explained in 3GPP document TS 38.323, clause 6.2.2.3. D/C field 1314 must be set to “D” for data. Data field 1315 contains uncompressed PDCP SDU or compressed PDCP SDU. MAC-I field 1313 carries a message authentication code.

FIG. 13c is a block schematic diagram illustrating a PDCP Data PDU for sidelink DRBs for unicast with 18 bits PDCP SN, which is an example of a PDU of application data, according to an embodiment of the invention.

In this embodiment, the PDU Set Keep Indication is implemented by a header extension, flagged by HE bit 1329. The header extension contains:
The FMC field 1326 is 32 bits wide and contain the COUNT value of a PDCP SDU to keep. Alternatively, the FMC field 1306 may contain the COUNT value of a first PDCP PDU to discard. COUNT is defined in TS 38.323, clause 6.3.5 as “The COUNT value is composed of a HFN and the PDCP SN. The size of the HFN part in bits is equal to 32 minus the length of the PDCP SN”. FMC field 1326 is optional and can be replaced by PDCP SN field 1322. PDCP SN field 1322 contains the PDCP sequence number of this PDCP PDU.
The bitmap length field 1327 provides the length of the bitmap field.
The bitmap field 1328 has a variable length. This field indicates which SDUs can be discarded and which SDUs must be kept by the receiving PDCP entity. The bit position of Nth bit in the Bitmap is N, i.e., the bit position of the first bit in the Bitmap is 1.

Other fields of the PDCP PDU are explained in 3GPP document TS 38.323, clause 6.2.2.7. D/C field 1324 must be set to “D” for data. Data field 1325 contains uncompressed PDCP SDU or compressed PDCP SDU. MAC-I field 1323 carries a message authentication code. SDU type field 1331 can be IP, Non-IP, Ethernet, Unstructured or ARP. KNRP field 1530 is an Identity as specified in TS 33.536.

FIG. 14 is a block schematic diagram illustrating a PDCP Control PDU for PDU Set Keep Indication, which is not an example of a PDU of application data, according to an embodiment of the invention.

In this embodiment, the PDU Set Keep Indication is implemented in a control PDCP PDU as follows:

The D/C field 1401 is 1 bit wide and shall be set to C for “Control”.

The PDU type field 1402 is 3 bits wide and shall be set to “100” for “PDU Set Keep Indication”. However, the present disclosure is not limited to this and other values like “101”, “110” or “111” can used instead.

There are 4 reserved bits 1403.

The FMC field 1404 is 32 bits wide and contain the COUNT value of a PDCP SDU to keep. Alternatively, the FMC field may contain the COUNT value of a first PDCP PDU to discard.

COUNT is defined in TS 38.323, clause 6.3.5 as

The COUNT value is composed of a HFN and the PDCP SN. The size of the HFN part in bits is equal to 32 minus the length of the PDCP SN.

The bitmap field 1405 has a variable length. This field indicates which SDUs can be discarded and which SDUs must be kept by the receiving PDCP entity. The bit position of Nth bit in the Bitmap is N, i.e., the bit position of the first bit in the Bitmap is 1.

Not referring to a particular figure, there are a number of configuration parameters that can be provided to a PDCP layer. In one example the configuration is provided by gNB to UE by RRC signalling. In another example the configuration is provided to gNB and UE by core network signalling. In another example the configuration parameters exist in UE and gNB as a pre-configuration.

The configuration parameter includes at least:
Whether PDCP PDUs flagged as “no keep” in “PDU Set Keep Indication” shall be delivered if already received.
Whether PDU Sets with PSIHI QoS parameter set to “true” shall be discarded in case of PDU Set delay budget expiration.
Whether PDU Set discard timers should used
Whether “PDU Set Keep Indication” shall be used.
Whether “PDU set Keep Indication” is preferred in PDCP Data PDU or sent as PDCP Control PDU.

As described above, the PDU Set Keep Indication is transmitted by the PDCP transmitter to the PDCP receiver and is configured to indicate second PDUs of the PDUs of the application data for the PDCP receiver to keep when the PDCP transmitter determines that the PDUs of a first PDU Set of the application data have not been fully received by the PDCP receiver.

The PDU Set Keep Indication may be included in a control PDU, in which case the FMC field of the control PDU may be set to indicate the PDUs to keep and/or discard. The Bitmap field of the control PDU may be set to indicate the PDUs to keep and/or discard.

Alternatively to including the PDU Set Keep Indication in the control PDU, the PDU Set Keep Indication may be included in a PDU of application data. In this case, the FMC field of the PDU of application data may be set to indicate the PDUs to keep and/or discard. The Bitmap field of the PDU of application data may be set to indicate the PDUs to keep and/or discard.

Forming the PDU Set Keep Indication as described above prevents an unnecessary increase in the amount of additional data (overhead) transmitted to the PDCP receiver.

Although the embodiments of the present invention have been described in relation to PDCP PDUs, the present invention is not limited to this type of PDUs. The methods of the present invention can be applied to the transmission and reception of any sequenced PDUs, in particular, the present invention is applicable to in-sequence PDU transmission on any layer.

According to embodiments of the present invention, the methods of controlling a PDCP transmitter and a PDCP receiver result in a reduction in the delay for PDCP PDU delivery due to an unreceived previous PDCP PDU without overly increasing overhead.

### Further Content Relevant to and Describing Further Embodiments of the Invention Follows

Liaison statement (R2-2300087, Reply LS on PDU Set Handling (S4aR230035; contact: Ericsson)), SA4 indicates that in-order delivery of PDUs is preferred.

“In-sequence delivery is preferred but not at the expense of introducing delay in delivery of packets to the RTP layer (i.e. latency that might be caused by the lower layers at the receiver side having to buffer and re-order packets before delivery to the RTP layer). Some codecs can take advantage of packets being delivered as soon as they are received at the lower layers (even if out-of-order). The SRTP/RTP receiver can perform re-ordering if needed.”

As indicated in the previous statement special care must be taken to avoid excessive delay being introduced for packet reordering.

For XR, two functions will be handled by PDCP, the PDU Set discarding as per RAN2 agreement (R2-2304202, Report on LTE legacy, XR, QoE and MUSIM) and the re-ordering of PDUs.

According to R17 PDCP specifications (TS 38.323, Packet Data Convergence Protocol (PDCP) specification, (Release 17)), PDU discard shall be indicated to lower layer.

“When the discardTimer expires for a PDCP SDU, or the successful delivery of a PDCP SDU is confirmed by PDCP status report, the transmitting PDCP entity shall discard the PDCP SDU along with the corresponding PDCP Data PDU. If the corresponding PDCP Data PDU has already been submitted to lower layers, the discard is indicated to lower layers.”

At lower layer discarding PDUs with allocated sequence numbers create gaps in PDCP sequence numbers at the receiving entity. This issue has been recognized and left for implementation in previous releases as stated in a note (TS 38.323, Packet Data Convergence Protocol (PDCP) specification, (Release 17)):

“NOTE: Discarding a PDCP SDU already associated with a PDCP SN causes a SN gap in the transmitted PDCP Data PDUs, which increases PDCP reordering delay in the receiving PDCP entity. It is up to UE implementation how to minimize SN gap after SDU discard”

By combining both the PDU Set discarding and the PDU reordering at PDCP layer, the following unwanted behaviour may happen:

Assuming the PDCP transmitting entity is sending PDCP PDUs belonging to a PDU Set, if at some point the PDCP transmitter detects that a PDU Set discarding condition is met concerning the PDU Set it is currently sending, then it shall discard the PDUs belonging to that PDU Set. The PDU Set discarding conditions includes PSIHI and delay budget or PDU loss. And at some other point, the PDCP transmitting entity starts sending PDCP PDUs belonging to a second PDU Set. At the receiving entity, the delivery to upper layers of the PDCP PDUs belonging to the second PDU Set may experience an additional delay of, at most, the value of the re-ordering counter (from 1 millisecond up-to 3 seconds) whilst waiting for PDCP PDUs belonging to the first PDU Set that will never be received because they will have been discarded. The worst case happens when the re-ordering timer starts counting only upon reception of the first PDCP PDU of the second PDU Set. This means that the previously received PDCP PDU has a non-contiguous sequence number compared to the newly received PDCP PDU.

Taking a closer look to the impact of re-ordering delay, RRC specifications (TS 38.331, Radio Resource Control (RRC) protocol specification, (Release 17)) defined t-ordering counter value as enumerated ms values from 0 to 3000. In RAN2 technical report ([8]. TR 38.835, NR; Study on XR enhancements for NR, (Release 18)), a target latency of 10 ms for video is proposed. Meaning t-ordering values of ms1, ms2, ms4, ms5 or ms8 represents already 10% to 80% of the total delay budget.

This additional delay clearly contradicts SA4 statement (R2-2300087, Reply LS on PDU Set Handling (S4aR230035; contact: Ericsson)) mentioned earlier that in-sequence delivery by RAN (UE or gNB) is preferred unless additional delay is introduced. Indeed, one millisecond to 3 seconds additional delay is not acceptable considering end-to-end latency requirement in the order of 10 milliseconds (TR 38.835, NR; Study on XR enhancements for NR, (Release 18)).

Leaving such uncertainty managed only by implementation choice makes it difficult to assess the fulfilment of an important requirement for XR.

Proposal 1: RAN2 to study how to solve the issue of SN gap caused by PDCP discarding.

By having knowledge of the PDU Set delimitations, the PDCP receiver would have been able to implement per PDU Set in-sequence delivery procedure preventing the discarding of one PDU Set influencing the delivery time of a second PDU Set. But in-band signalling of PDU Set delimitation information represents too much added overhead, and there is a high risk to defeat the purpose of bandwidth saving by PDU Set discarding.

Proposal 2: RAN 2 to study a method to minimize the additional delay due to in-sequence delivery of PDCP PDUs in the event of PDU Set Discarding while minimizing the induced overhead.

When discarding PDUs with already assigned SN, the PDCP transmitting entity shall signal the discard operation to the remote PDCP receiving entity.

The real issue arises when a second PDU Set is being sent, so it is not mandatory to send a signalling immediately when a PDCP discard occurs.

Proposal 3: When discarding PDUs with already assigned SN, the PDCP transmitting entity shall signal the discard operation to the remote PDCP receiving entity when a second PDU Set is sent.

Different PDU Sets can be multiplexed in the same DRB. At PDCP receiving entity there may be several SN gaps, some related to an explicit discard operation performed by the remote PDCP transmitting entity and some related to transmission errors. The discard signalling sent by the remote PDCP transmitting entity shall allow the PDCP receiving entity to discern clearly between the existing gaps.

Proposal 4: The PDCP discard signalling to include information about PDUs belonging to different PDU Sets.

### Yet Further Content Relevant to and Describing Further Embodiments of the Invention Follows

In document R2-2313946 (Need for PDCP discard notifications to receiving PDCP entity), the delay impact is identified as the t_ordering timer duration. With the assumption that this timer is typically set to almost PDB (PDU Delay Budget), it is argued that the delay impact would not exceed the PDB and hence would be transparent.

It is considered that the impact shall be measured with regard to PSDB (PDU Set delay budget) rather than PDB. XR users will be impacted if the PDU Sets are delivered out of the PSDB window. It is possible that a PSDB window is reached while each PDU respects their individual PDB. According to the stage 2 specs of 3GPP document TS 38.300 (v18.0.0.0), the PSDB supersedes PDB:

PSDB: as defined in TS 23.501 (e.g., TR 38.835, NR; Study on XR enhancements for NR, (Release 18)), the upper bound for the duration between the reception time of the first PDU (at the UPF for download (DL), at the UE for upload (UL)) and the time when all PDUs of a PDU Set have been successfully received (at the UE in DL, at the UPF in UL). A QoS Flow is associated with only one PSDB, and when available, it applies to both DL and upload UL and supersedes the PDB of the QoS flow.

Observation 1: The Impact of t_ordering timer shall be measured with respect to PSDB rather than PDB.

Taking a closer look at the impact of re-ordering delay, RRC specifications (TS 38.331, Radio Resource Control (RRC) protocol specification, (Release 17), the t-ordering counter value is defined as comprising enumerated ms values from 0 to 3000. In RAN2 technical report (TR 38.835, NR; Study on XR enhancements for NR, (Release 18)), a target latency of 10 ms for video is proposed. Meaning t-ordering values of ms1, ms2, ms4, ms5 or ms8 represents already 10% to80 % of the total PSDB.

This additional delay contradicts the SA4 statement (R2-2300087, Reply LS on PDU Set Handling (S4aR230035), which describes earlier that in-sequence delivery by RAN (UE or gNB) is preferred unless an additional delay is introduced. Indeed, one (1) millisecond to three (3) seconds additional delay is not acceptable considering end-to-end latency requirement in the order of ten (10) milliseconds (TR 38.835, NR; Study on XR enhancements for NR, (Release 18)).

Observation 2: The impact of t_ordering timer with respect to PSDB is not acceptable in the case of stringent latency requirements.

Moreover, PDU Sets interleaving can happen when PDUs of different PDU Sets are multiplexed in one DRB, typically, different slices with common QoS requirements. When PDUs of different PDU sets get multiplexed, one t_ordering timer of one PDU of one PDU Set will block other PDUs from a second PDU Set.

Assuming the PDCP transmitting entity is sending PDCP PDUs belonging to a PDU Set, if at some point the PDCP transmitter detects that a PDU Set discarding condition is met concerning the PDU Set it is currently sending, then it shall discard the PDUs belonging to that PDU Set. The PDU Set discarding conditions include PSIHI and delay budget or PDU loss. And at some other point, the PDCP transmitting entity starts sending PDCP PDUs belonging to a second PDU Set. At the receiving entity, the delivery to the upper layers of the PDCP PDUs belonging to the second PDU Set may experience an additional delay of, at most, the value of the re-ordering counter (from 1 millisecond up-to 3 seconds) whilst waiting for PDCP PDUs belonging to the first PDU Set that will never be received because they will have been discarded. The worst case happens when the re-ordering timer starts counting upon reception of the first PDCP PDU of the second PDU Set, i.e., when the previously received PDCP PDU has a non-contiguous sequence number compared to this first PDCP PDU of the second PDU Set.

Observation 3: The impact is even worse when PDU Sets are multiplexed.

A second alternative concept is considered which implements the signalling of discarded PDUs in a new PDCP control message similar to a PDCP status report.

While the present invention has been described with reference to examples and embodiments, it is to be understood that the invention is not limited to the disclosed examples and embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fibre optic cable, twisted pair, digital subscriber line (DSL), or wireless technologies such as infrared, radio, and microwave, then the coaxial cable, fibre optic cable, twisted pair, DSL, or wireless technologies such as infrared, radio, and microwave may be included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1. A method for controlling a packet data convergence protocol, PDCP, in a communication network defined in the 3^{rd} Generation Partnership Project, 3GPP, standard comprising a transmitter and a receiver, the method at the transmitter comprising:
following transmission of one or more PDCP service data units, SDUs, to the receiver and following satisfaction of at least one trigger condition which includes
that a PDCP SDU of the one or more transmitted PDCP SDUs has been discarded by the transmitter,
transmitting to the receiver a bitmap field to indicate information regarding the discard status of the one or more transmitted PDCP SDUs.

2. The method of claim 1, wherein the bitmap field is sent separately to, or inserted in, a PDCP SDU for transmitting to the receiver.

3. (canceled)

4. The method of claim 2, wherein the bitmap field is included in a control protocol date unit, PDU.

5. The method of claim 3, wherein the bitmap field is one bit in a PDCP SDU or is an addition to the header of the a PDCP SDU.

6. The method of claim 1, further comprising:
setting a bitmap field to indicate to a PDCP function implemented at the transmitter to:
send the bitmap field when a PDCP SDU which is not discarded is ready to be sent to the receiver, or
discard data units of the application data received from an upper layer of the protocol stack.

7. (canceled)

8. The method of claim 6, wherein if the received data units of the application data belonging to a same PDU Set as the discarded PDCP SDU have been sent, by the PDCP function, to a lower layer of the protocol stack, the method further comprises notifying the lower layer to discard any on-going transmission of the PDCP SDUs from the same PDU Set.

9. The method of claim 1, further comprising:
initialising a discard timer upon receiving, at a PDCP function implemented at the transmitter, an SDU from an upper layer,
wherein determining that the PDCP SDU has been discarded by the transmitter comprises determining that the discard timer has expired without receiving acknowledgement of reception of the discarded PDCP SDU from the receiver.

10. The method of claim 9, wherein the discard timer is a PDU Discard timer started when receiving the SDU from the upper layer or a PDU Set Discard timer started when receiving a first SDU of a PDU Set.

11. The method claim 1, wherein the determining that the PDCP SDU has been discarded comprises receiving a report from the receiver indicating that the PDU Set to which the discarded PDCP SDU belongs has not been fully received.

12. The method of claim 1, further comprising:
determining a PDU Set Integrated Handling Indication, PSIHI, PDU Set QoS parameter for the PDU Set to which the discarded PDCP SDU belongs,
wherein the bitmap field is transmitted to the PDCP receiver only if the value of PSIHI parameter is set to a predetermined value.

13. The method of claim 1, wherein the PDU Set sequence number of the PDU Set to which the discarded PDCP SDU belongs is used to identify the discarded PDUs.

14. The method claim 1, further comprising:
determining if the discarded PDCP SDU is part of an extended Reality, XR, PDU Set,
wherein the bitmap field is transmitted to the PDCP receiver only if the discarded PDCP SDU is part of an extended Reality, XR, PDU Set.

15. A method for controlling a packet data convergence protocol, PDCP, in a communication network comprising a transmitter and a receiver, the method at the receiver comprising:
following receipt of one or more service data units, SDU, from the transmitter and following satisfaction of at least one trigger condition which includes that a PDCP SDU of the one or more transmitted PDCP SDUs has been discarded by the transmitter, receiving from the transmitter a bitmap field which indicates information regarding the discard status of the one or more transmitted PDCP SDUs; and
discarding any PDCP SDUs which are indicated by the bitmap field to have been discarded.

16. The method of claim 15, further comprising:
initialising a re-ordering timer when receiving an out of order PDCP SDU, and
resetting the re-ordering timer after receiving the bitmap field.

17. The method of claim 15, wherein the receiving the bitmap field comprises checking a header of the received PDCP SDU for the bitmap field and/or receiving the bitmap field separately to the one or more PDCP SDUs.

18. (canceled)

19. The method of claim 15, wherein discarding the PDCP SDU which are indicated by the bitmap field to have been discarded by the transmitter comprises discarding one or more pending PDCP SDUs received before the bitmap field.

20. The method of claim 15, wherein the method further comprises delivering, by a PDCP function implemented at the receiver, a stored PDCP SDU to an upper layer based on the bitmap field.

21. (canceled)

22. (canceled)

23. (canceled)

24. A non-transitory computer readable medium carrying instructions which, when the program is executed by a transmitter, cause the transmitter to carry out the method according to claim 1.

25. (canceled)

26. The method of claim 1, wherein the transmitter is a User Equipment, UE, defined in the 3GPP standard, or a next generation Node B, gNB, defined in the 3GPP standard.

27. The method of claim 15, wherein the receiver is a User Equipment, UE, defined in the 3GPP standard, or a next generation Node B, gNB, defined in the 3GPP standard.
